(19) United States
(12) Patent Application Publication
(10) Pub. No.: US 2003/0033192 A1
(43) Pub. Date: Feb. 13, 2003

(54) Strategic marketing planning processes, marketing effectiveness tools ans systems, and marketing investment management

(76) Inventors: Sergio Zyman, Atlanta, GA (US); Jim Phillips, Alpharetta, GA (US); Chris Malone, Dunwoody, GA (US); Jerry Howard, Alpharetta, GA (US); Chris O'Neill, Alpharetta, GA (US); Lara Moore, Smyrna, GA (US); Dave Singleton, Marietta, GA (US); Scott Engels, Atlanta, GA (US); Aydin D. Keskiner, Atlanta, GA (US); Michael Sinclair, Atlanta, GA (US); Tom Klein, Atlanta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/919,320

(22) Filed: Jul. 31, 2001

Related U.S. Application Data
(60) Provisional application No. 60/222,375, filed on Jul. 31, 2000.
(60) Provisional application No. 60/257,426, filed on Dec. 21, 2000.
(60) Provisional application No. 60/266,963, filed on Feb. 6, 2001.
(60) Provisional application No. 60/280,045, filed on Mar. 30, 2001.
(60) Provisional application No. 60/287,714, filed on May 1, 2001.

(51) Int. Cl. G06F 17/60

(52) U.S. Cl. 705/10

(57) ABSTRACT

Planning tools guide marketing professionals through steps of performing a situation assessment, identifying opportunities, developing growth strategies, developing growth tactics, and developing measurements. The planning tools provide disciplined processes in a question and answer format. The tools are personalized to the answers given by marketing professionals and new tools or modified tools can be easily implemented. These tools can be provided in a stand-alone manner, as part of a network, and as part of a collaborative environment. The planning tools preferably form part of an entire marketing investment manager which includes a marketing management solution, digital asset management, and hooks to existing systems, such as customer relationship management, finance, manufacturing, and information technology. The marketing management solution adopts best practices and includes collaboration, project management, campaign management, and analytics, and measurement units.

### RELATED APPLICATIONS

This application claims priority to, and incorporates by reference, co-pending provisional patent application Serial No. 60/222,375 filed Jul. 31, 2000, entitled “Methods and Systems for Providing Marketing Professionals Access to Skill, Knowledge, and Marketing Tools”; Serial No. 60/257,426 filed Dec. 21, 2000, entitled “Promotional Tools and Methods and Systems for Providing Such Tools Over the Internet”; Serial No. 60/266,963 filed Feb. 6, 2001, entitled “Performance Assessment Tools and Methods and Systems for Providing Such Tools Over the Internet”; Serial No. 60/280,045 filed Mar. 30, 2001, entitled “Branding Tools and Methods and Systems for Providing Such Tools Over the Internet”; and Serial No. 60/287,714 filed May 2, 2001, entitled “newspaper Tools and Methods and Systems For Providing Such Tools Over the Internet.”

### BACKGROUND OF THE INVENTION

Marketing is an essential aspect of any successful business. Through effective marketing, businesses can develop product policy, determine pricing, produce effective advertising and communications, perform better marketing research, and understand channels of distribution. Marketing also allows businesses to understand customer behavior, competitive marketing activities, and organizational considerations.

While marketing is an essential component of any business, unfortunately many businesses are unable to perform effective marketing. Many small businesses simply cannot afford to devote sufficient resources to marketing. In addition to a lack of resources, many businesses also do not have the requisite expertise in marketing. As a result, many businesses rely upon marketing consultants to fill this gap.

As mentioned above, businesses that have insufficient resources or inexperienced marketing people can benefit from marketing assistance. In addition to these businesses, even businesses that have a full staff of marketing people and/or marketing consultants can benefit from additional assistance. Many marketing professionals go to seminars or read books from well respected marketers, such as Sergio Zyman, and try to emulate his practices. While certainly helpful, marketing professionals cannot reap the full benefit of an individual's expertise merely through a book or seminar.

A need therefore exists for additional ways in which marketing professionals can obtain assistance. A number of web sites exist on the Internet that provide articles and other content on how to effectively market one's business. In the end, however, the marketing professionals are still left on their own when planning, executing, or evaluating their marketing efforts. In addition to these websites, numerous software applications exist to assist in a discrete aspect of marketing. For instance, some of these applications may be directed toward developing direct mail to consumers as a result of data mining techniques. Other software applications may be directed toward targeting advertising to consumers based on their interests. These software applications have a narrow focus and do not address all of a marketing professional's needs.

A number of patents have issued which relate in one way or another to marketing. As with the software applications mentioned above, some of these patents relate to profiling customers in order to gain a better understanding of the customer's interests. For example, U.S. Pat. Nos. 6,236,975; 6,202,210; and 6,078,891 generally relate to collecting and processing data on customers to allow companies to better target their products or services to those customers. Other patents generally relate to the use of computers in actually marketing goods or services to the customers. For example, U.S. Pat. Nos. 6,058,418; 5,659,469; and 5,649,114 all relate to systems or methods for marketing goods or services to customers. Thus, in general, these patents relate to either collecting and analyzing data on customers or delivering advertisements or other such promotional items to customers. These patents therefore do not describe systems that provide assistance to marketing professionals in actually formulating a marketing strategy.

As is apparent from the description above, many of the approaches that have been taken are rather limited and do not offer a complete solution to a company's marketing needs. While some products are touted as being an enterprise marketing solution, such products often are highly focused on project management, CRM, email campaigns, or some other discrete aspect of execution. One difficulty in providing such a solution is that marketing has traditionally been seen as a purely creative process and one that is hard to measure. Thus, the marketing departments of many companies are controlled primarily through budgetary constraints and not by any requirement to produce quantifiable results. A need therefore exists for systems and methods that offer a complete marketing solution and that provide assistance to a company in all phases of marketing and furthermore which are integrated into the entire business enterprise, not just to marketing.

### SUMMARY OF THE INVENTION

The present invention addresses the problems described above by providing systems, methods, and tools to assist marketing professionals in making their marketing efforts more effective and more efficient. The systems provide information to help users become more effective marketers. The systems also provide marketing professionals access to the skill, knowledge, and marketing tools they need to accelerate their businesses' revenue and profit growth. The system has integrated content tools that guide users through proven processes and which reflect the knowledge and experience of leading marketing professionals, preferably Sergio Zyman, the Zyman Marketing Group, and other subject matter experts. The tools that are available through the system guide users through all phases of marketing, including planning, executing, and evaluating.

According to one aspect, a planning tool involves a method of situation assessment, identifying opportunities, developing growth strategies, developing growth tactics, and developing measurements. A situation assessment process according to the invention is preferably implemented in a question and answer format with answers to the questions leading to findings. The situation assessment involves a multi-prong approach looking at a business assessment, category assessment, brand assessment, and competitive assessment. Furthermore, each of these assessments includes multiple subject matter, such as volume, profit, and marketing spending within business assessment. The process of situation assessment involves taking findings from within each subject matter and drawing preliminary conclusions. The process then involves looking at the preliminary conclusions to draw final conclusions for each of business assessment, category assessment, brand assessment, and competitive assessment. The outputs of the assessments, including the final conclusions, form the input to the next step of identifying opportunities. In the identification of opportunities process, targets, wants/needs, and strengths/barriers are used in deriving an opportunity statement. The growth strategies are then developed to realize the opportunities, which includes taking an inventory and assessment of assets and capabilities.

According to another aspect, a plurality of tools are provided which assist marketing professionals in planning, executing, and tracking results. These tools are interconnected to each other whereby outputs from planning tools form the inputs to executing tools and outputs from executing tools form inputs to tracking tools. Furthermore, the tools are iterative whereby the results of tracking tools are fed back as inputs to planning tools. In this manner, marketing tools according to the invention provide a complete solution to all of a company's marketing needs. The tools also are preferably personalized to a customer or user. For example, inputs provided by a user are fed forward to subsequent questions and answers and are evaluated in determining which questions will be provided to the user. These tools are preferably provided through an engine that is controlled by logic within modular software components. The data is contained in XML and can be easily altered so as to modify, to delete, or to add new tools.

The tools are preferably provided in a network environment leveraging both client-server and/or distributed environments. The tools form part of a marketing investment manager which provides a complete marketing solution for an entity. Marketing professionals can view projects to which they are assigned, communicate with people associated with those projects, and track one or more calendars associated with those projects. Additionally, professionals can gain access to tools and other functionality which assist and guide marketing professionals in performing their job. These jobs including planning tools, executing tools, and tracking tools and are preferably integrated with customer relationship management, financial, and manufacturing systems. The marketing investment manager also includes digital asset management for managing advertisements, promotions, and other digital assets of a company.

### BRIEF DESCRIPTION OF THE DRAWINGS

The accompanying drawings, which are incorporated in and form a part of the specification, illustrate preferred embodiments of the present invention and, together with the description, disclose the principles of the invention. In the drawings:

FIG. 1 is a diagram of tools according to a preferred embodiment of the invention;

FIG. 2 is an example of an interface to the tools;

FIG. 3 is an example of an interface welcoming a user;

FIG. 4 is an interface providing some assistance in navigating through the tools;

FIG. 5 is an example of how a document may be copied through the tools;

FIG. 6 is an example of an interface whereby users can set permissions;

FIG. 7 is a diagram of a network according to a preferred embodiment of the invention;

FIGS. 8(A) and 8(B) are diagrams of a preferred architecture according to the invention;

FIGS. 9(A) to 9(G) are exemplary screen shots to a system according to the invention;

FIGS. 10(A) to 10(D) provide an overall introduction to a planning tool;

FIGS. 11(A) to 11(H) provide an introduction to a situation assessment step of the planning tool;

FIGS. 12(A) to 12(D) provide an introduction to an identification of opportunities step of the tool;

FIGS. 13(A) to 13(F) provide an introduction to a development of growth strategies step of the tool;

FIGS. 14(A) to 14(E) provide an introduction to a development of growth tactics step of the tool;

FIGS. 15(A) to 15(E) provide an introduction to development of measurements step of the planning tool;

FIG. 16 is an introduction to the beginning of the tool;

FIG. 17 is an example of an interface where a user inputs a brand and a time period associated with the brand;

FIGS. 18(A) to 18(N) are examples of interfaces used within the situation assessment step of the planning tool;

FIG. 19 is an example of an interface in the identification of opportunities step of the planning tool;

FIG. 20 is an example of an interface in the development of growth strategies step of the planning tool;

FIG. 21 is an example of an interface in the development of growth tactics step of the tool;

FIG. 22 is an example of an interface in the development of measurements step of the tool;

FIG. 23 is an example of an interface providing an output of the planning tool;

FIG. 24 is a more detailed diagram illustrating a personalization aspect of the tools;

FIG. 25 is an example of a main interface to a marketing investment manager aspect of the invention;

FIG. 26 is an interface to a 3 Year Marketing Plan project showing a results history;

FIG. 27 is an interface showing use of a planning tool with the 3 Year Marketing Plan project;

FIG. 28 illustrates use of a Return On Investment (ROI) analysis tool on a Thanksgiving FSI project;

FIG. 29 illustrates use of a positioning tool on the Thanksgiving FSI;

FIG. 30 is an example of an interface showing use of a promotions tool with the Thanksgiving FSI;

FIG. 31 is an interface showing a digital asset management feature of the marketing investment manager;

FIG. 32 is an interface showing a collaboration feature of the marketing investment manager;

FIG. 33 is an interface showing an example of a project management feature of the marketing investment manager;

FIG. 34 is an interface illustrating use of a budget tool with a September EMail campaign;

FIG. 35 is an interface showing use of a campaign management tool within the marketing investment manager;

FIG. 36 is an interface showing summaries of multiple projects, such as for viewing by a vice-president;

FIG. 37 is a diagram of a marketing investment manager system;

FIG. 38 is an illustrative diagram of a marketing investment manager solution; and

FIG. 39 is a diagram of a distributed client server environment suitable for use by systems and methods of the invention.

### DETAILED DESCRIPTION

Reference will now be made in detail to preferred embodiments of the invention, non-limiting examples of which are illustrated in the accompanying drawings.

I. Overview of Tools

Efforts in marketing can be divided into roughly three groups: planning for marketing, execution, and evaluation. Whereas conventional marketing efforts may be performed in-house and/or with the assistance of consultants, systems and methods according to the invention employ tools that guide users through the planning, executing, and evaluating phases of marketing. Some examples of such tools for planning include a planning tool, a brand positioning tool, and a new brands tool. Examples of tools for executing include an advertising tool, a promotions tool, a research tool, a properties tool, an endorsements tool, a merchandising tool, a media tool, a PR tool, a sales tool, a pricing tool, and a CRM tool. The third phase, the Tracking the Results phase, includes a market tracking tool, a brand tracking tool, an industry tracking tool, a consumer tracking tool, and a comprehensive tracking tool. Each tool preferably does not operate in a vacuum but is used in conjunction with other tools within the same phase and also is used in coordination with tools in other phases in order to provide a complete solution.

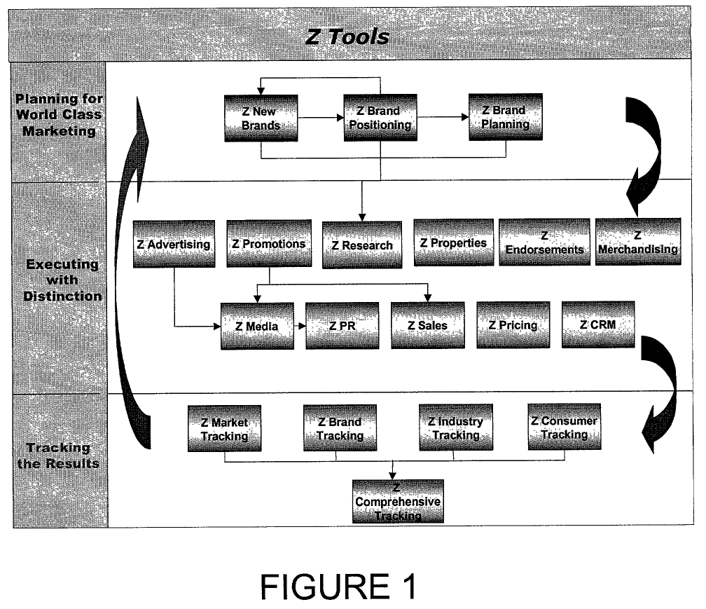

FIG. 1 illustrates a preferred interconnection between tools according to the invention. As shown in this diagram, tools are divided into planning tools, executing tools, and tracking tools. Within one particular type of tools, such as planning tools, the tools can be interconnected to each other as shown with the new brands, brand positioning, and brand planning tools. In other words, the results of brand positioning may be provided to new brands tool and also to the brand planning tool. In addition to interconnections between tools of one particular type, the different types of tools are interconnected whereby planning tools provide outputs to executing tools, executing tools provide outputs to tracking tools, and tracking tools provide input back to the planning tools. Thus, use of the tools can be an iterative process.

With the tools that are available through the systems, marketing professionals around the world can track their brands, build or adjust their brand plans, kick off a new promotion, manage a research project in progress, and plan, execute, and track their marketing efforts in other ways. These tools have been defined and formulated by analyzing Sergio Zyman and Zyman Marketing Group best practices and provide automated integration between planning, executing, and tracking. The tools reduce or eliminate the need for users organizations to build IT infrastructure or organization to support marketing.

In general, each tool guides the users through market analyses by using well-defined processes. The tools are often query-based and prompt a user through the process. The planning tools take advantage of drop-down menus to provide a series of alternative answers that the users can use to facilitate the process and may include links to other content and tools to allow the user to make use of additional available resources. The tools may also use templates that help users conduct analysis, organize thoughts, and develop final presentations. The system also provides secure servers to allow users direct access via use of their own personal user ID.

A brief description of some exemplary tools is provided below in Table 1.

TABLE 1

| | ZTOOLS | Description |
|---|---|---|
| | | ZTOOLS—FOUNDATION |
| | PHASE I | MARKETING ELEMENTS |
| 1 | Z Brand Planning | Create a 30-day to 3-year comprehensive |
| | | plan for your brand through an automated |
| | | fact-driven planning process. The process |
| | | starts with an extensive situation |
| | | assessment and proceeds through |
| | | development and execution of growth |
| | | strategies and tactics. |
| | | Outputs include a full marketing plan |
| | | and an integrated schedule of programs |
| | | that identify cross-functional |
| | | interdependencies. |
| 2 | Z Brand Positioning | Develop or strengthen your brand's |
| | | positioning with a 5-step process that |
| | | includes destination planning, situation |
| | | assessment, identification of strategic |
| | | opportunities, hypothesis validation, and |
| | | positioning development. At the |
| | | completion of the process you will have a |
| | | brand positioning statement, a brand |
| | | architecture that will help you bring it to |
| | | life, and the insights and facts to support |
| | | the final positioning that will differentiate |
| | | your branded product and service bundle |
| | | from the competition in the minds of |
| | | your target. |
| | | ZTOOLS—MARKETING MIX |
| | PHASE II | ELEMENTS |
| 3 | Z Advertising | Develop effective advertising that |
| | | increases purchase intent and builds |
| | | brand equity via a multi-step process that |
| | | covers development of a communication |
| | | strategy and a creative brief, selection |
| | | and compensation of an agency, and |
| | | tracking of in-market results. It |
| | | provides a step-by-step approach for |
| | | determining if your advertising is on- |
| | | strategy and identifying the key measures |
| | | of success. Outputs include a |
| | | communication strategy, creative brief, |
| | | methodologies for consumer testing, and |
| | | guidelines for managing an effective |
| | | relationship with your agency. |
| 4 | Z Media | Develop an effective media plan by |
| | | assessing the ability of different media |
| | | to reach your target audience. Determine |
| | | how to set the right reach and frequency |
| | | objectives and build a media plan that |
| | | delivers against those objectives in the |
| | | most cost-efficient manner possible. |
| | | Outputs includes assessments of |
| | | alternative media, alignment with key |
| | | marketing objectives, optimized flighting, |
| | | integration with key marketing programs, |
| | | and optimal placement within media type. |
| 5 | Z Merchandising | Develop and place effective |
| | | merchandising by understanding |
| | | purchasing behaviors and the motivations |
| | | that affect these behaviors. Learn how |
| | | to develop point-of-sale merchandising |
| | | communication that works synergistically |
| | | with your advertising to build brand |
| | | equity, and where to place your |
| | | merchandising for optimal impact. |
| | | Determine the importance of |
| | | merchandising in your overall marketing |
| | | plan. Outputs include an in-store |
| | | messaging strategy, an in-store media |
| | | strategy, a proximity marketing plan, |
| | | and guidelines for placement and |
| | | replacement. |
| 6 | Z Pricing | Develop a pricing strategy for your brands |
| | | or services via a disciplined process that |
| | | includes analysis of price gaps versus |
| | | competition, consumer purchasing and |
| | | usage dynamics, and margins versus |
| | | contribution to total profit. |
| | | Determine whether different strategies |
| | | are needed for different targets and/or |
| | | different channels of distribution. |
| | | Features of this tool include interactive |
| | | analytical templates that facilitate |
| | | competitive analysis, research |
| | | methodologies that allow you to |
| | | determine price elasticities of demand |
| | | for your branded product and service |
| | | bundle, and exercises that will facilitate |
| | | the setting of pricing strategies based |
| | | on your marketplace position and |
| | | marketing objectives. |
| 7 | Z Promotions | Maximize the potential of your promotions |
| | | by linking the promotion theme, rewards, |
| | | and mechanics to the brand's overall |
| | | positioning and strategy. Ensure relevance |
| | | to the target and break through the |
| | | cluttered environment by understanding |
| | | your consumer and leveraging innovation. |
| | | Drive incremental and sustainable volume |
| | | for your brand while demonstrating and |
| | | reinforcing your brand's key benefits. |
| | | Features of this tool include promotion |
| | | strategy development, concept |
| | | development and validation, and execution |
| | | planning templates. |
| 8 | Z Research | Conduct research in support of any |
| | Z Presearch | marketing issue or opportunity via a |
| | Z Trends | structured process that helps you clarify |
| | | your objectives, design the research, select |
| | | a supplier, and analyze the results. This |
| | | tool can be used across all types of |
| | | ad-hoc and in-market tracking studies, |
| | | and for monitoring consumer trends that |
| | | affect attitudes and behaviors across |
| | | multiple categories. Outputs include |
| | | templates for research briefs, final reports, |
| | | and suggestions for increasing the |
| | | actionability of any research project. |
| | | ZTOOLS—SPECIALTY |
| | PHASE III | MARKETING MIX |
| 9 | Z Competitive Strategy | Leverage your unique competitive |
| | | advantage vs. both individual competitive |
| | | brands as well as competitive product or |
| | | service categories. Learn how to identify |
| | | your real competitors through analysis of |
| | | your target's wants and needs by |
| | | activity and occasion. Understand which |
| | | product or service features and benefits |
| | | are owned by your brand, owned by |
| | | competitive brands, open opportunities |
| | | to all brands, or price-of-entry to your |
| | | competitive set. Features of this tool |
| | | include an equity marketing approach and |
| | | operational marketing approach, including |
| | | strategies and tactics that allow your brand |
| | | to compete and win from the standpoints |
| | | of both attitude/imagery and sales/profits. |
| 10 | Z Customer Marketing | Use the power of your branded product or |
| | | service to create value for your targets' |
| | | brands. Learn how to develop a value |
| | | creation model that explains whether, |
| | | how, and to what degree value accrues to |
| | | all constituents in your value chain, |
| | | including your customers, clients, |
| | | consumers, or end-users, and those of |
| | | your customers. Demonstrate to your |
| | | customers how your brands deliver value |
| | | in the form of incremental brand imagery |
| | | and sales and profits, and use this |
| | | information to capture your fair share of |
| | | margin from the value chain. Understand |
| | | how to identify the intersection of your |
| | | customers' brand architectures with |
| | | that of your own, and use this information |
| | | to develop a strategic marketing plan and |
| | | co-branding tactics customized specifically |
| | | for each of your customers. Features of |
| | | this tool include interactive templates that |
| | | enable you to develop for each of your |
| | | customers a customer management |
| | | strategy, a customer brand architecture, |
| | | and co-branding strategies and tactics. |
| 11 | Z Endorsements | Determine whether celebrity endorsements |
| | | should be a part of your marketing |
| | | strategies and plans. If so, this tool will |
| | | help you screen and select endorsements |
| | | that are consistent with the strategy for |
| | | your branded product or service and |
| | | can enhance your brand's equity, while |
| | | also driving short and long-term revenue. |
| | | Outputs of this tool include an |
| | | endorsement strategy for the brand, a |
| | | endorsement screening approach, concept |
| | | development and validation, results |
| | | measurement approaches, and executional |
| | | planning templates. |
| 12 | Z Graphics & Icons | Leverage the visual power of your branded |
| | | product or service, by unlocking the latent |
| | | symbols that your target associates with |
| | | your brand. Learn how to translate your |
| | | brand's iconography into communicate |
| | | strategies and concepts, including both |
| | | messages and graphics. Activate these |
| | | communication strategies across all |
| | | elements of your marketing mix, |
| | | including brand identity, advertising, |
| | | merchandising, packaging, signage, trade |
| | | collateral, and even uniforms for your |
| | | personnel and new graphics for your fleet. |
| 13 | Z Licensed Properties | Understand the dual role of licensing, |
| | Z Licensing | including licensing your own branded |
| | Z Properties | product or service and pursuing other |
| | | properties, licensed or otherwise, that |
| | | support your brand. Expand your own |
| | | licensing activities beyond the traditional |
| | | role of defending your trademarks, to |
| | | generate new revenue and profit streams, |
| | | while enhancing the equity of your brand |
| | | as an intellectual property. Learn how |
| | | to forge relevant and enduring |
| | | relationships with your target by |
| | | leveraging both your own brand equity, |
| | | as well as that of those properties |
| | | licensed to you. Determine which of your |
| | | brand's licensing activities and other |
| | | licensed properties are most consistent |
| | | with your brand strategy. Learn how to |
| | | exploit the “badge value” of |
| | | your brand by extending them to other |
| | | product categories where your target can |
| | | use and display them publicly, |
| | | prominently, and proudly to others. |
| | | Learn how to leverage this badge value |
| | | of your brand and other licensed properties |
| | | to transform your target into more loyal |
| | | and frequent users (“core users”) |
| | | of your brand. |
| 14 | Z New Brands | Identify opportunities for new products, |
| | | develop alternative ideas, screen for initial |
| | | consumer acceptance, optimize appeal via |
| | | executional elements, test for consumer |
| | | acceptance, develop a complete marketing |
| | | plan and introduce into the marketplace. |
| 15 | Z Occasion Marketing | Understand how to segment your market |
| | | into occasions and activities pursued by |
| | | your target. Determine the underlying |
| | | wants and needs of your target by |
| | | occasion. Rank occasions by quantifiable |
| | | measures, such as transactions, revenues, |
| | | or profits, and size these opportunities |
| | | for your brand. Identify market barriers |
| | | to accessing each of these business |
| | | opportunities, and then develop |
| | | strategies and tactics to overcome |
| | | each of these barriers. Assign likelihoods |
| | | to each set of strategies and tactics, |
| | | based on the difficulty of overcoming |
| | | market barriers. Outputs of this tool |
| | | include occasion matrices by product or |
| | | service category, ranked opportunities |
| | | for incremental transactions, revenue, |
| | | and profit, and sets of strategies and |
| | | tactics by occasion. |
| 16 | Z Public Relations | Develop a strategy to use public relations |
| | | as an effective element of your marketing |
| | | mix. Determine how public relations can |
| | | support your brand objectives and |
| | | strategies. Understand how public |
| | | relations can work synergistically with |
| | | other elements of the mix, like advertising, |
| | | merchandising, packaging, etc. Identify |
| | | your target, develop communication |
| | | strategies, and translate these |
| | | strategies into media messages. |
| 17 | Z Sponsorships | Understand how to strategically use |
| | | sponsorships to add value to your |
| | | marketing efforts and enhance your |
| | | brand's imagery. Understand how to |
| | | evaluate the wide variety of sponsorship |
| | | options available, based on a combination |
| | | of investment level and the ability to |
| | | activate your sponsorship to create value |
| | | for your brand. Develop negotiating |
| | | strategies based on your marketing needs |
| | | instead of the standard sponsorship |
| | | packages available. |
| 18 | Z Channels | Develop channel strategies and activation |
| | | plans that help sell more stuff for more |
| | | money. Evaluate the different dynamics |
| | | of your brand's various trade or |
| | | selling channels and create activation |
| | | plans that leverage those different |
| | | dynamics. Leverage the distinct consumer |
| | | and customer buying behaviors and price |
| | | sensitivities across those channels to |
| | | develop more effective marketing plans. |
| 19 | Z Local Brands | Understand how to unlock the power of |
| | | local brands in your portfolio. Evaluate |
| | | whether your marketing plans should look |
| | | to consolidate your portfolio into one |
| | | global or national brand, or to leverage |
| | | individual local brands. Whether through |
| | | new brand launches or acquisitions, |
| | | understanding how and when to market |
| | | local brands will maximize the |
| | | effectiveness of your portfolio. |
| 20 | Z Asset Management | Understand how to identify and leverage |
| | | your brand and Company marketing |
| | | assets. Uncover value in your strategic |
| | | alliances, sponsorships and other industry |
| | | relationships. Establish routines to |
| | | protect the assets and to ensure that you |
| | | are using them to create value and sales |
| | | for your brands. |
| 21 | Z Personal Branding | Develop a strategy to maximize your |
| | | personal value as a brand. Apply the |
| | | principles of Z Marketing branding efforts |
| | | to your own career. Identify a destination |
| | | for yourself, develop a positioning |
| | | statement, and learn how to activate |
| | | your strongest attributes in the |
| | | marketplace. |
| 22 | CRM | Manage knowledge of customers and other |
| | | aspects of customer relationship |
| | | management. |
| 23 | Campaign Management | Manage campaigns, such as email |
| | | campaigns. |
| 24 | Digital Asset | Inventory, monitor, control, and otherwise |
| | Management | manage digital assets used in all phases of |
| | | marketing, such as advertisement. |
| 25 | Elearning/ZLearning | Provide coursework, seminars, articles, |
| | | consulting services, and other educational |
| | | assistance in all phases of marketing and |
| | | in use of the tools. |

II. Methods of Using Tools

As will be described in more detail below, the tools can be made available to users in a variety of ways through various systems, networks, and configurations. The tools themselves are not limited to any such system, network, or configuration but instead can be adopted by a user in ways that are deemed most appropriate by those users. An exemplary set of interfaces will be discussed below in order to provide an overview as to how marketing tools according to the invention may be used.

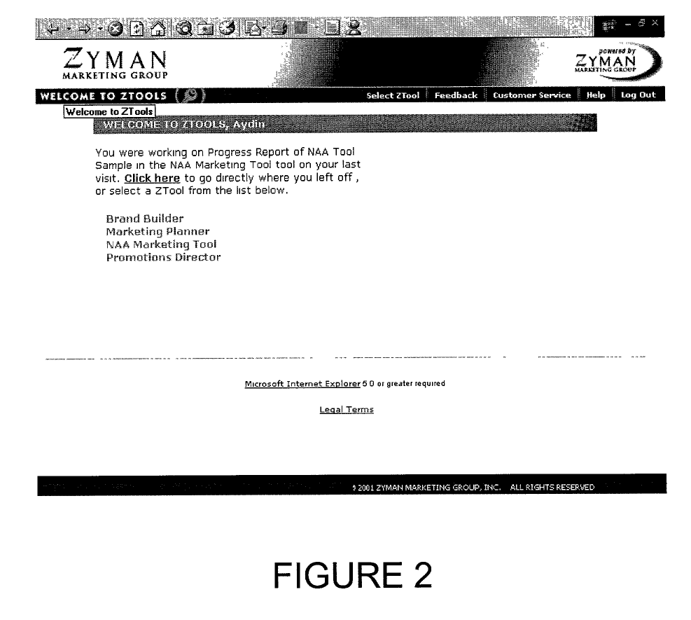

An example of an interface presenting a group of tools to a user is shown in FIG. 2. Preferably, when the user arrives at this interface shown in FIG. 2, the user receives a welcome message and their name and also displays the last tool the current user had worked on with a hyperlink to the last page edited. The user is presented with a list of all tools available with hyperlinks only to those tools that the user has purchased. The interface preferably has a link so that the user can purchase the additional tools if desired. After a user clicks on a tool to work in, the user is taken to the document menu screen for that particular tool.

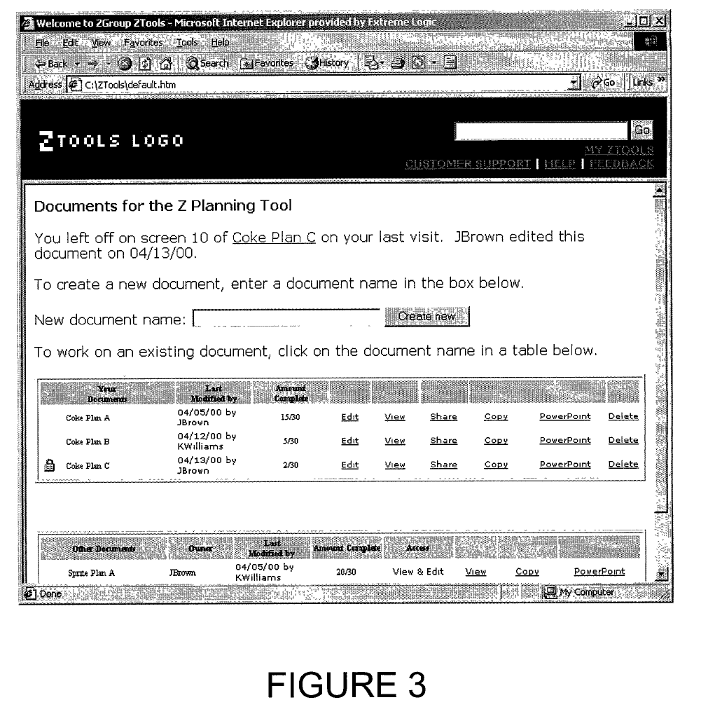

An example of a document menu screen for the ZPlanning tool is shown in FIG. 3. In this example, the user had progressed to screen 10 of the tool for a plan named Coke Plan C. The interface shown in FIG. 3 also reveals that another user, named JBrown had edited the document and also shows the edit date. The document menu screen allows the user to create a new document or work on an existing document. The document menu screen preferably also shows the user's progress in completing a tool, such as by showing an amount complete or graphically, such as through a bar graph.

For new documents, a user sets the permission levels for other users. In this regard, more than one person can work with a particular tool. If a user has been granted editing capabilities, then the user can open a file, go to the last screen edited, and begin work. If the user has not been granted editing capabilities, then the user has “View Only” permissions. According to one aspect, only one user at a time can have access to a particular file and a lock icon shows the lock status of a file. When a file is in use by another user, the lock icon next to that file is displayed in the interface for that other user. When this user does a mouseover over the icon, a title tag is preferably displayed with the name of the person that has the document. According to another aspect, users may be able to share files simultaneously in real-time and can work in a collaborative environment according to teams assigned to a project.

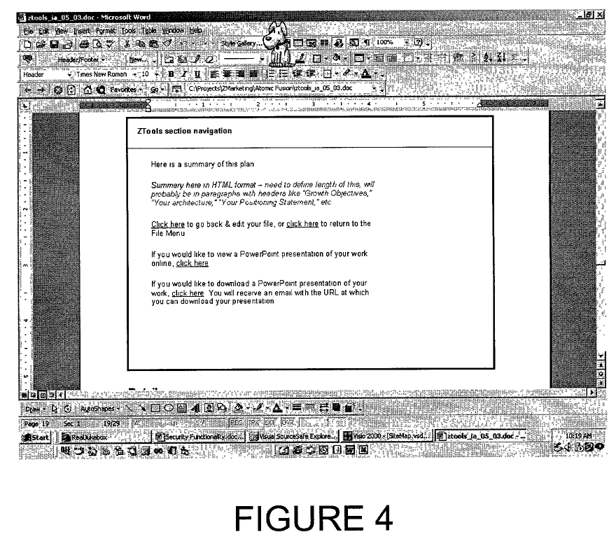

A Summary is preferably provided after a user finishes a particular tool. An example of a Summary is shown in FIG. 4. In this example, an HTML Summary is provided for all questions and answers that were built and presented to the user. In addition to an HTML Summary, the user can view a presentation of the Summary or download the presentation to another location.

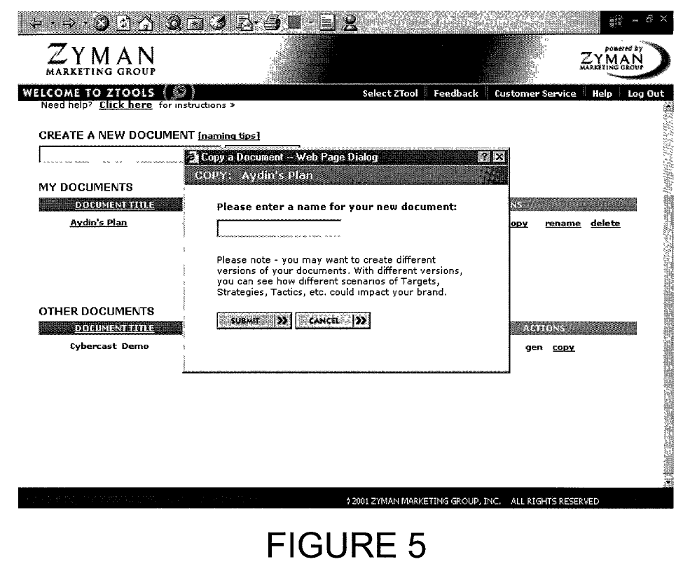

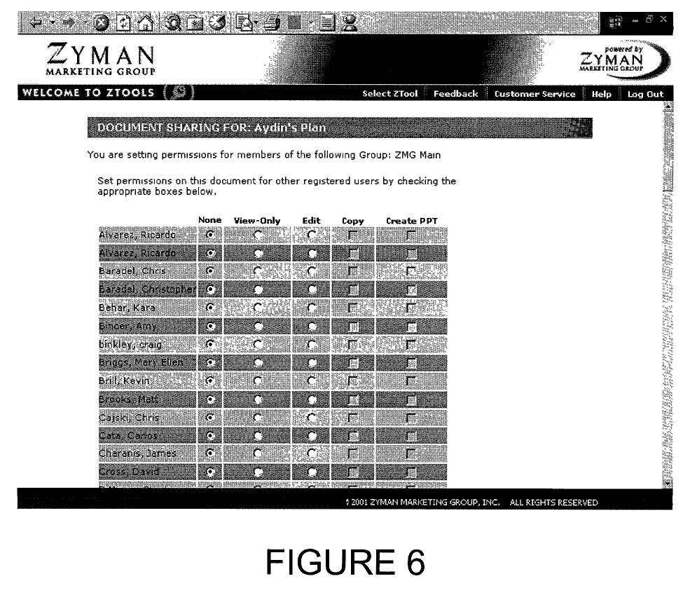

A user has options to create/edit a document, view a document, assign permissions, copy the document, and also delete the document. FIG. 5 is an example of an interface for allowing the user to copy a file and FIG. 6 is an example of an interface allowing a user to set permissions. The permissions that may be set include none, view only, edit ability, copy ability, or the ability to view or download a presentation, such as PowerPoint presentation.

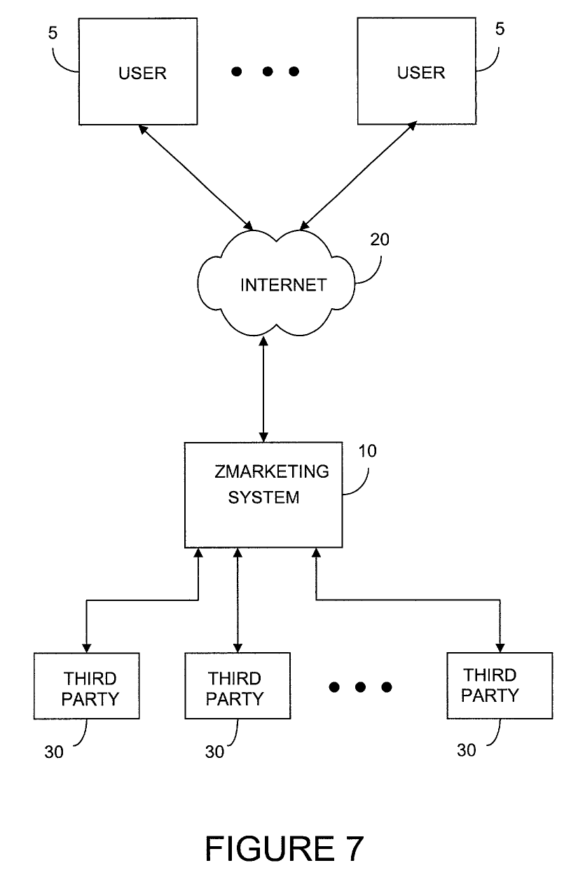

A network according to an embodiment of the invention is shown in FIG. 7. The network includes a marketing system 10 that provides access to marketing tools to one or more users 5. The users 5 may access the marketing system 10 directly, such as on a stand-alone computer, or through a network 20. The system 10 may additionally be coupled to, or interfaced with, one or more third parties. The users may use any suitable device for accessing the system including, but not limited to, personal computers, personal digital assistants (PDAs), mobile radio telephones, internet appliances, as well as other types of devices. While the system is preferably accessible through the Internet, it should be understood that in other embodiments of the invention, the system may reside in a stand-alone device such as a personal computer, within a network, such as a local area network (LAN) or wide area network (WAN), or accessible through other networks. As mentioned above, the invention can be implemented in different systems and networks.

III. Application Service Provider

As mentioned above, systems according to the invention can be implement locally, such as on stand-along computer or within a LAN, or may be implemented through a network. According to one embodiment of the invention, a system is implemented as an application service provider (ASP) wherein users can access the tools through the Internet. In the preferred embodiment, the system is associated with a marketing vertical web-site that enables marketing professionals anywhere and everywhere to make their marketing efforts work harder and smarter. As will be described in more detail below, the system includes a number of tools, insights, and alliance partners that are uniquely available through the system.

The users include clients, system administrators, subscribers, consultants, and guests. In general, the clients pay a license fee to use the various tools to plan, execute, and track marketing campaigns. The client administrator oversees system administration, such as managing the list of users that are licensed to use the tools. The users may also include subscribers who pay for services available through the system, such as those available at the system or through the third parties. Thus, the users can interact with these third parties as though the third parties were part of the ASP and can also interact and access applications available through these third parties. The users also include guests which are able to access portions of the system and possibly third parties without any fee.

The invention is not limited in the type of third party that interfaces with or couples to the system. These third parties include advertising agencies, research providers, media providers, tracking data providers, as well as other third party service providers. These third parties can interact with the users in a manner that is either visible or transparent to the users. In other words, the users may not necessarily be aware that any third party is associated with the operation of the system. The system preferably includes a tools application server for operation of a unique set of tools and also a Zmarketing application server for interfacing with subscribers, guests, and third parties.

A. Network and Architecture

As should be clear from the description above, the systems and methods may be implemented in an ASP environment but certainly are not limited to just an ASP environment. Instead, the systems and methods of the invention can evolve as new technologies are introduced, such as Microsoft .NET. Other examples include client-server and also hybrid client-server/distributed environments.

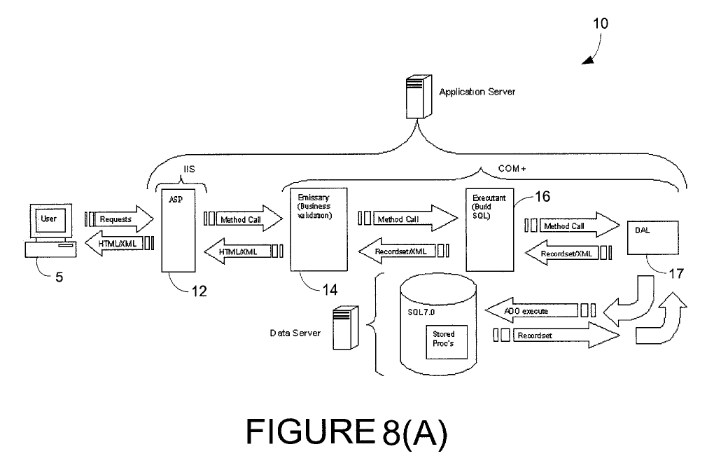

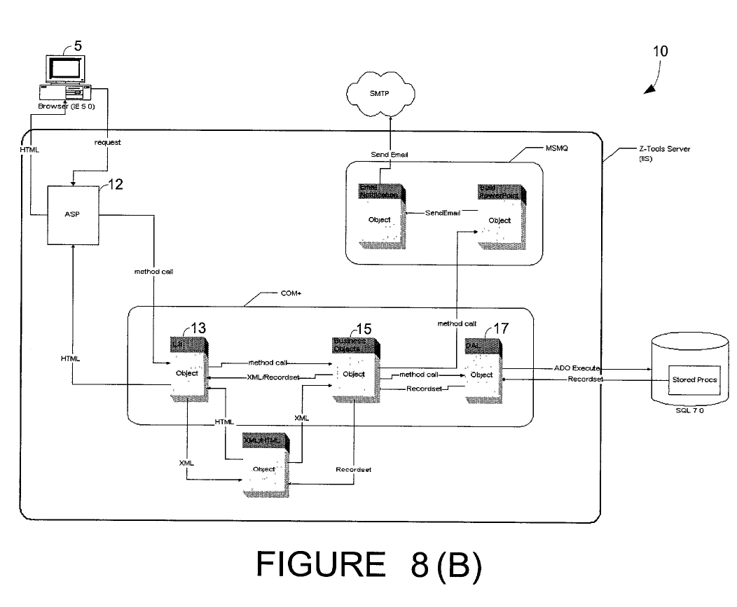

An example of an architecture for an ASP system 10 is shown in FIGS. 8(A) and 8(B). The architecture shown in FIGS. 8(A) and 8(B) is based on the Microsoft® Windows® Distributed interNet Applications Architecture (Windows DNA) which is a three-tiered application whose functionality can be separated into presentation services, business services, and data services. In general, the presentation services include obtaining information from users 5, sending user information to the business services for processing, receiving the results of the business services, and presenting those results to the users 5.

The business services include receiving input from the presentation services, processing information and performing application logic, interacting with the data services to perform the business operations, and sending the processed results to the presentation services. The data services include storage, retrieval, maintenance, and integrity of data. The presentation service is labeled as the User Interface (UI) 13, the business services is designated as the Business Layer (BL) 15, and the data services is designated as the Data Access Layer (DAL) 17 in FIG. 8(B). As shown in FIG. 8(A), the business layer 15 include executants 16 that perform the business operations of the operation logic and have direct access to the application's critical resources. The business layer 15 also includes emissaries 14 which authenticate the identity of a requesting client 5, validates that the client 5 has the proper authorization to perform the requested business operation, and inspects the client's request for proper syntax and valid data.

B. Interfaces

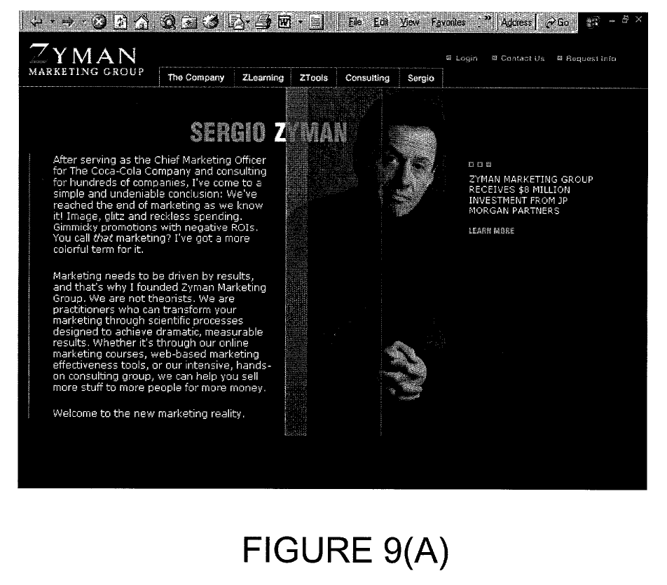

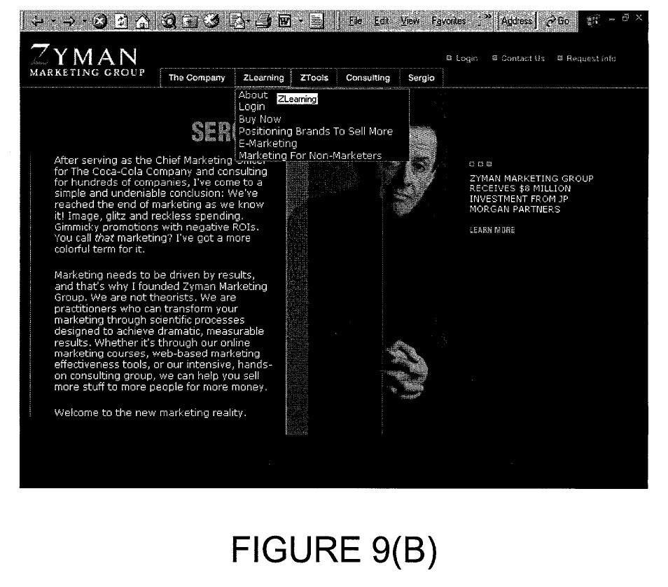

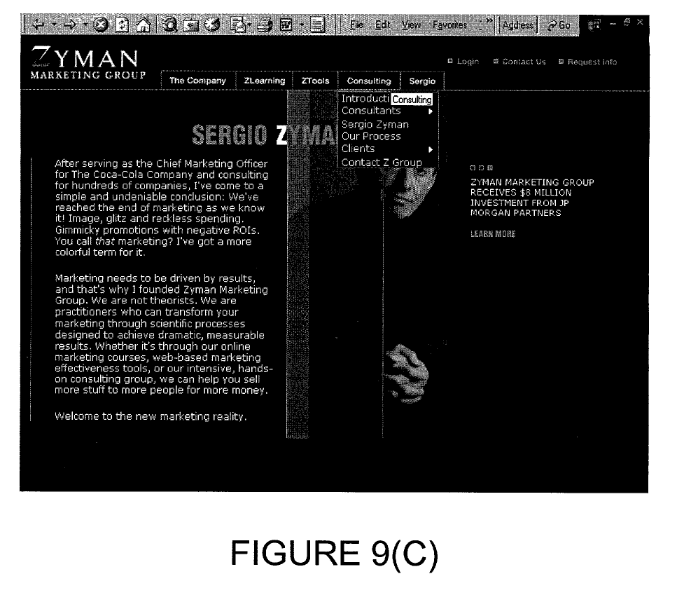

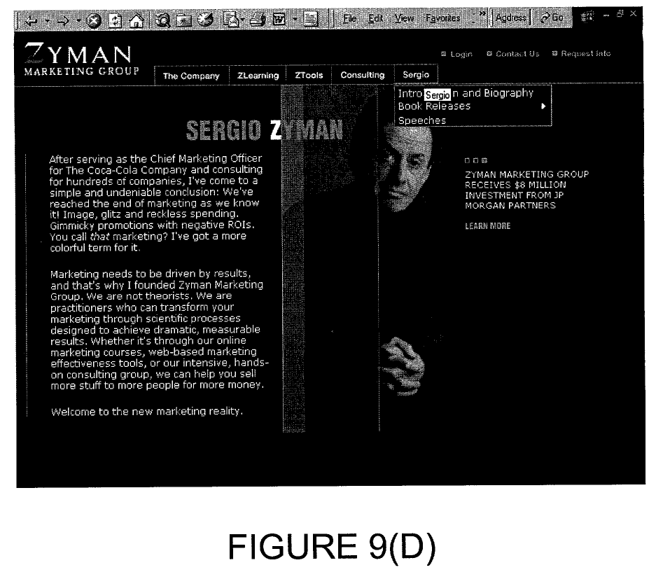

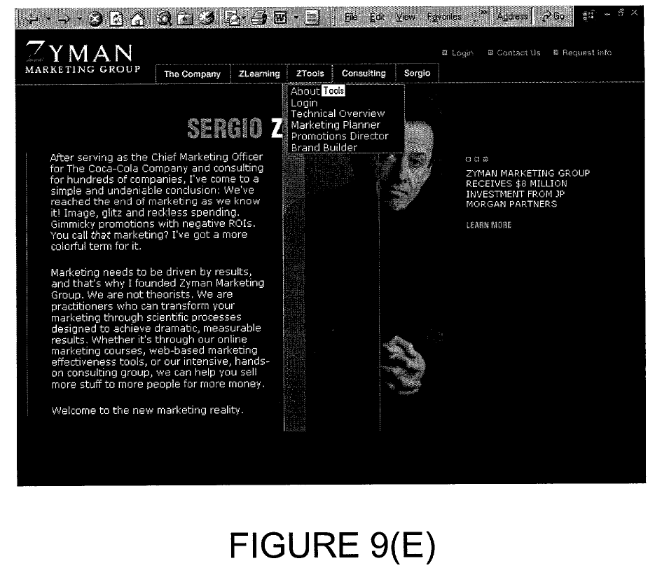

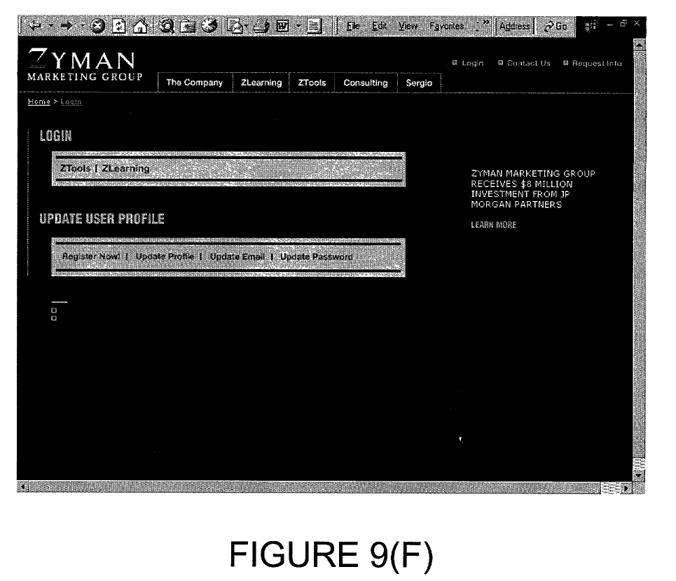

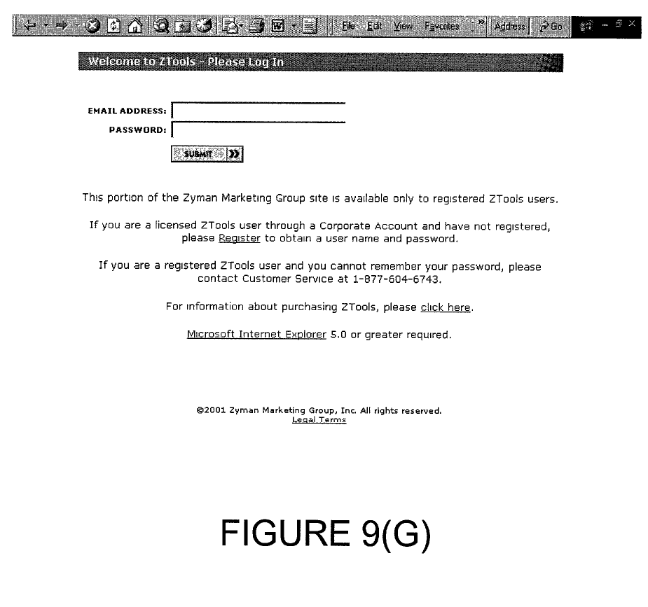

FIGS. 9(A) to 9(G) provide examples of interfaces to the ASP system 10. FIG. 9(A) is an example of a main interface to the ASP system 10 where a user can select a “ZLearning” heading and obtain the interface shown in FIG. 9(B), a “Consulting” heading and obtain the interface shown in FIG. 9(C), a “Sergio” heading and obtain the interface shown in FIG. 9(D), or select a “ZTools” heading and obtain the interface shown in FIG. 9(E). The user can also obtain more information on the company associated with the ASP system 10 by selecting “The Company” heading. The user can also select a “Login” link and obtain a login interface shown in FIG. 9(F). As shown in FIG. 9(E), the user can also obtain a “Login” option through the “ZTools” heading, and then receive an interface shown in FIG. 9(G).

With the ASP system 10, the user can access the tools, enroll in one or more courses through the “ZLearning” heading, and also learn more about consulting services available through the ASP system 10 with the “Consulting” heading. The ASP system 10 serves as a source of information for marketing professionals and also provides access to consultants and other resources that may assist marketing professionals perform their jobs. The ASP system 10 furthermore provides the tools necessary to guide marketing professionals through the various tasks associated with marketing.

IV. Planning Tool

A planning tool according to a preferred embodiment guides a user through a number of steps. The planning tool includes steps of assessing the business situation, identifying growth opportunities, developing strategies/objectives, developing growth tactics, executing growth tactics, and measuring results. Each step within a particular tool preferably contains a number of sub-steps.

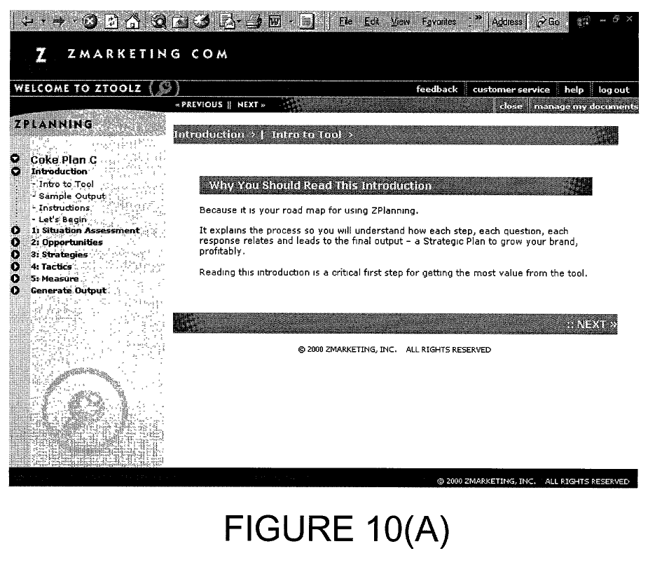

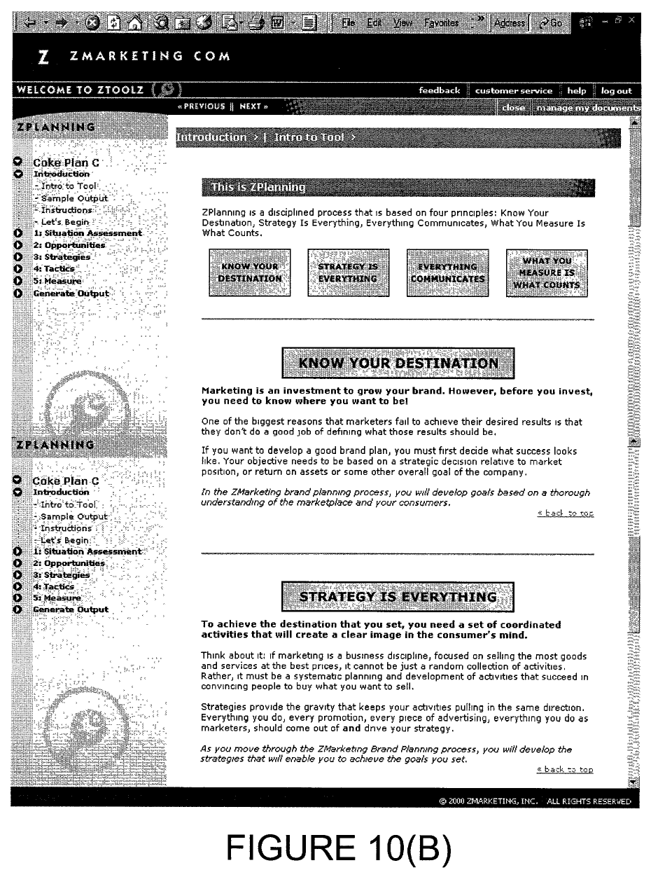

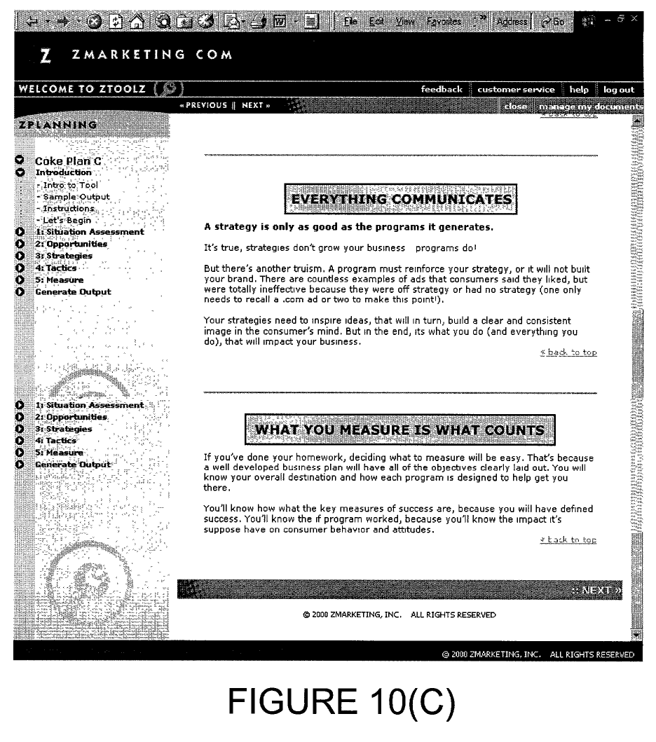

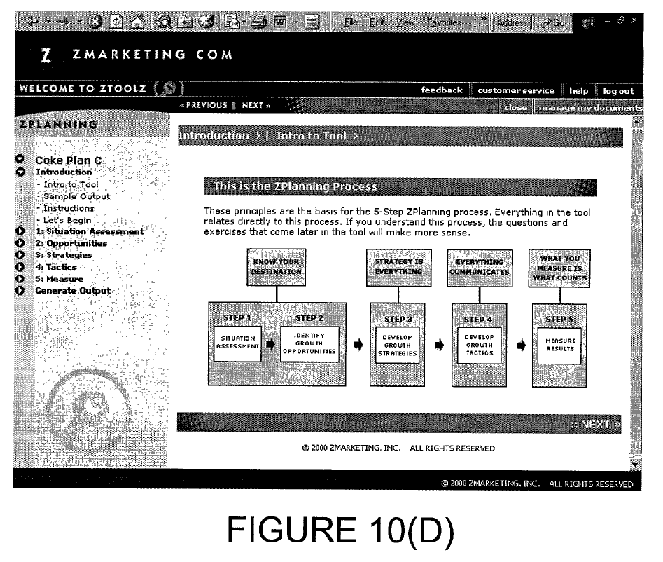

FIGS. 10(A) to 10(D) are interfaces that provide an introduction to using the planning tool. As shown in FIG. 10(D), the planning process implemented by a planning tool according to the invention involves a situation assessment, identifying growth opportunities, developing growth strategies, developing growth tactics, and measuring results. The first two steps are labeled as part of the goal of “Knowing Your Destination” while the last three steps are associated with statements of “Strategy is Everything,” “Everything Communicates,” and “What You Measure Is What Counts,” respectively.

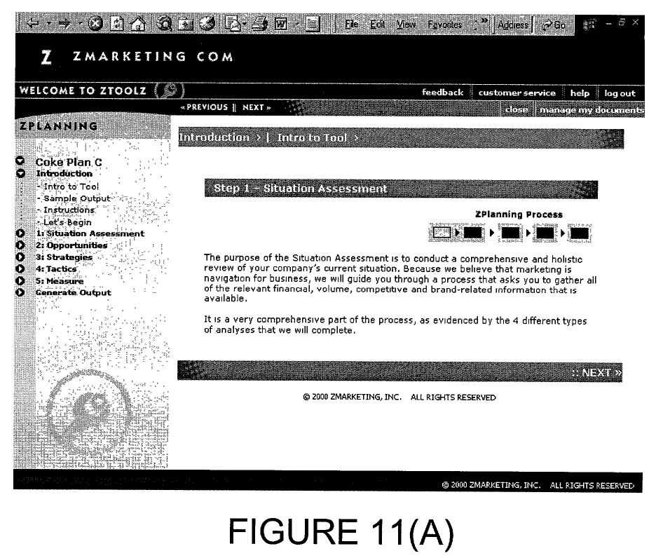

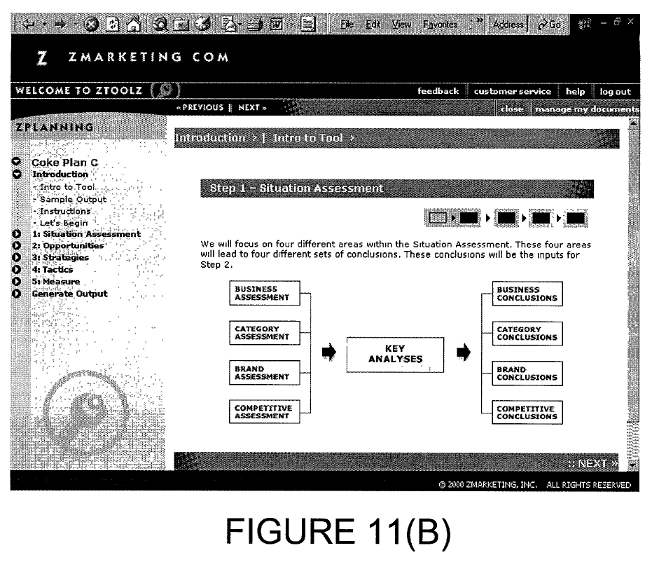

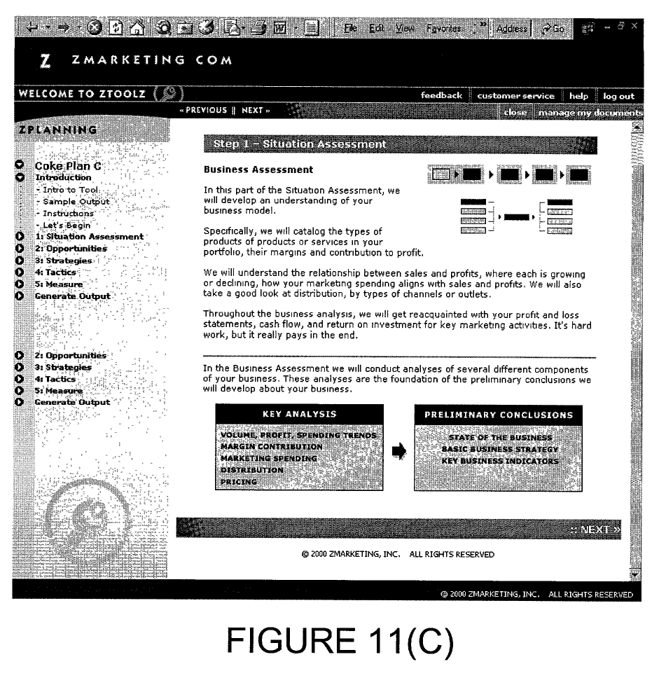

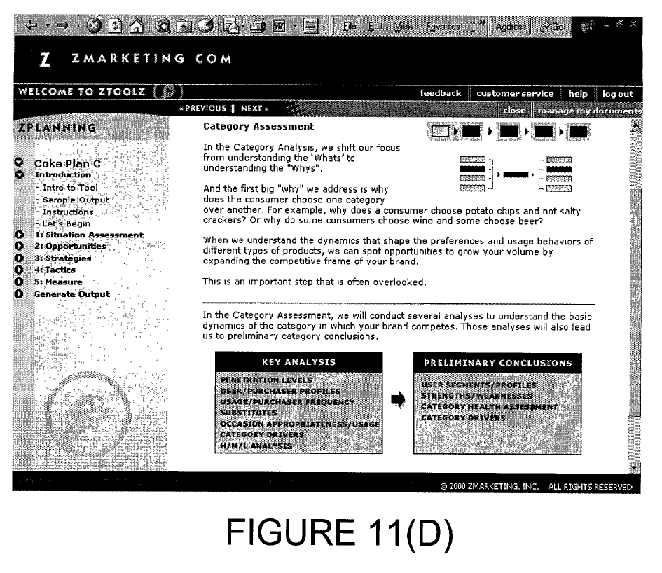

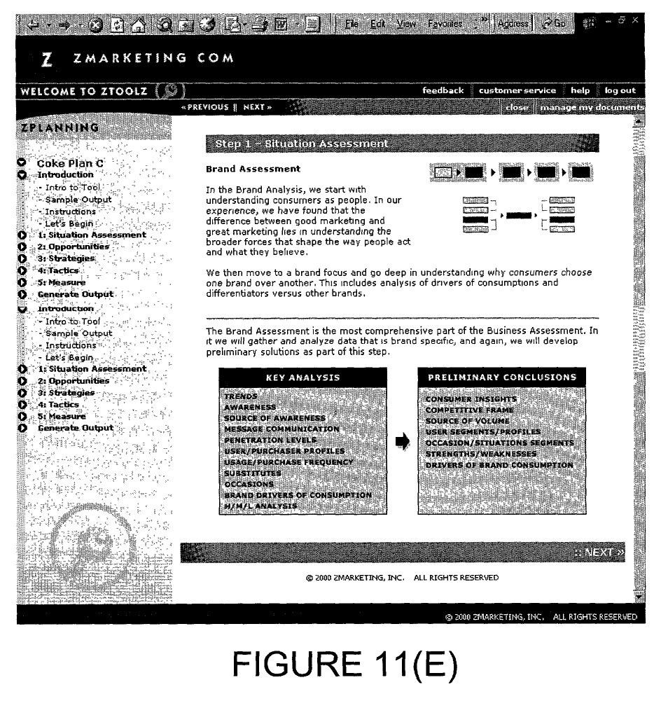

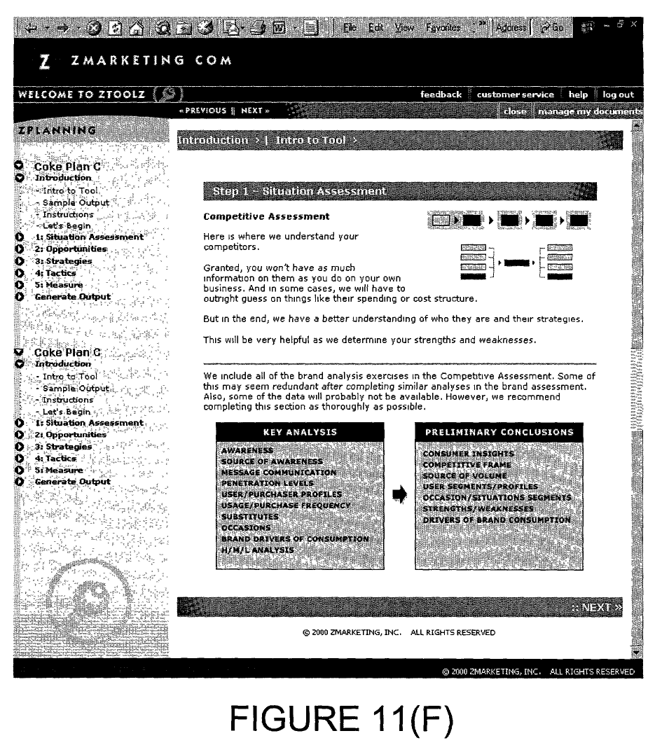

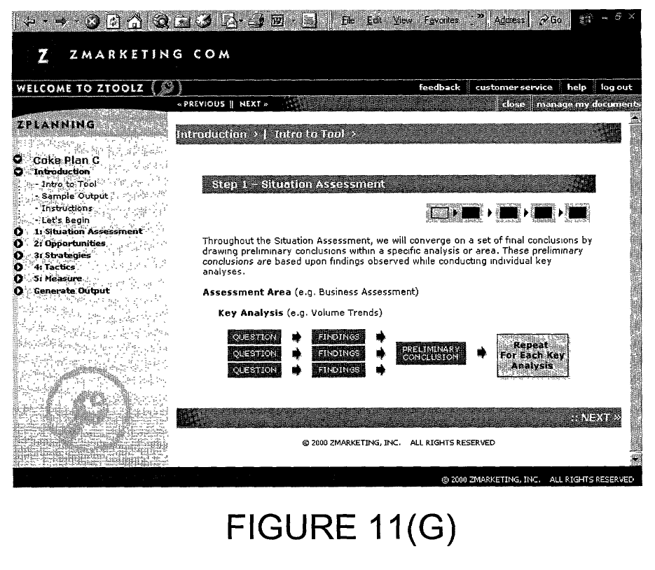

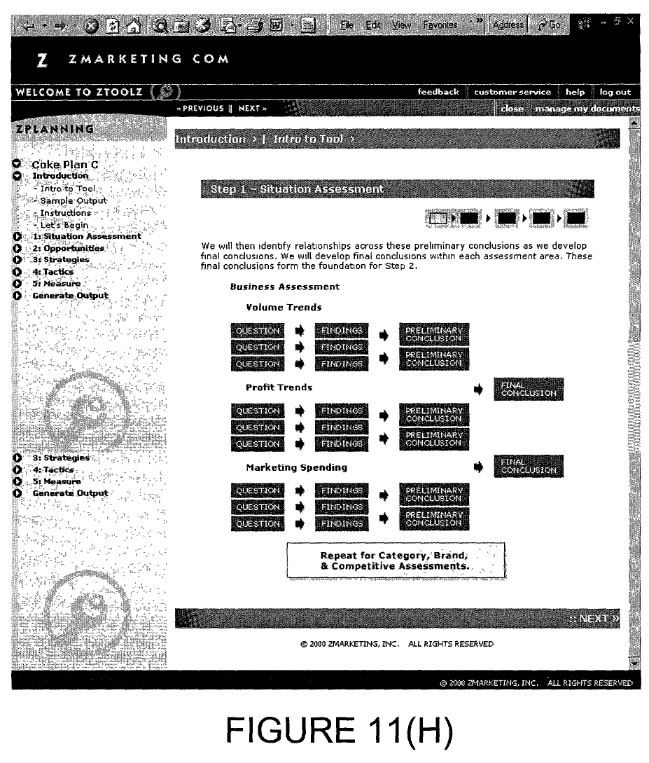

FIGS. 11(A) to 11(H) provide an introduction to the first step, namely situation assessment. As explained in FIG. 11(A), a purpose of the situation assessment is to conduct a comprehensive and holistic review of a company's current situation. As explained in FIG. 11(B), the situation assessment focuses on four different areas including business assessment, category assessment, brand assessment, and competitive assessment. From each of these assessments, a corresponding set of conclusions are derived, which provide the input for the second step of identifying opportunities. FIGS. 11(C) to 11(F) provide an explanation for each of the business assessment, category assessment, brand assessment, and competitive assessment and how each of these assessments leads to preliminary conclusions. As summarized in FIG. 11(G), questions within the planning tool guide users to findings. The users then take each of the findings and draw preliminary conclusions which then converge into a set of final conclusions. FIG. 11(H) provides more detailed diagram of this process which involves drawing findings within a series of questions within the business assessment sub-step. The business assessment involves evaluating volume trends, profit trends, and marketing spending and within each of these subject matters a user draws findings followed by preliminary conclusions. The user then evaluates these preliminary conclusions in order to draw final conclusions across subject matters. The user also performs similar analysis for category, brand, and competitive assessments.

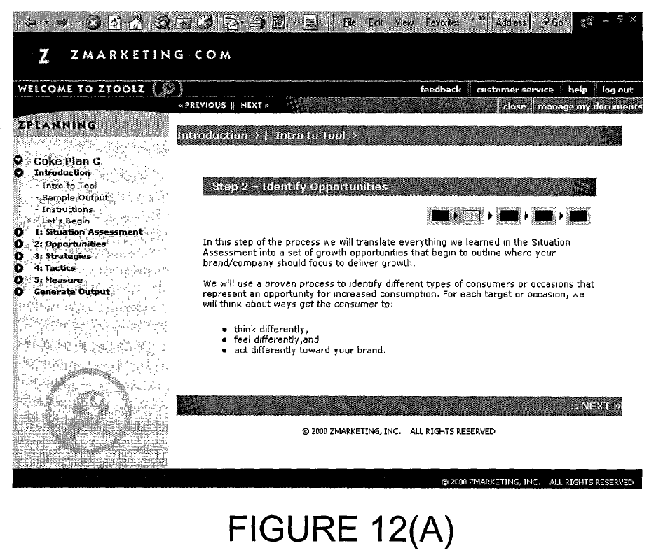

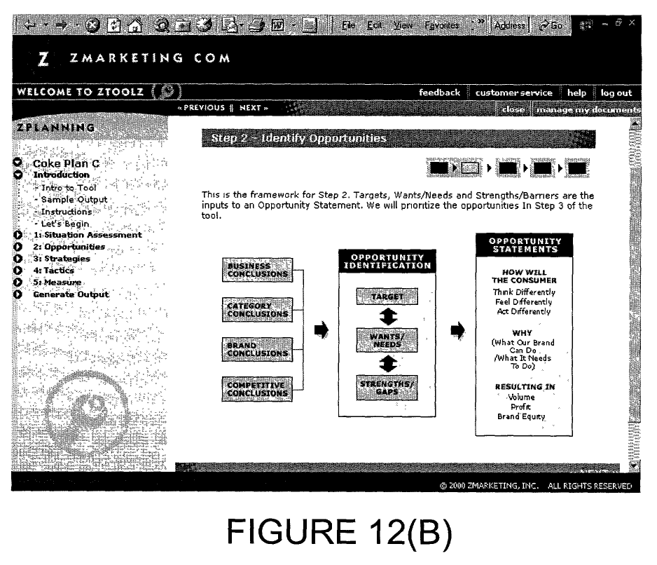

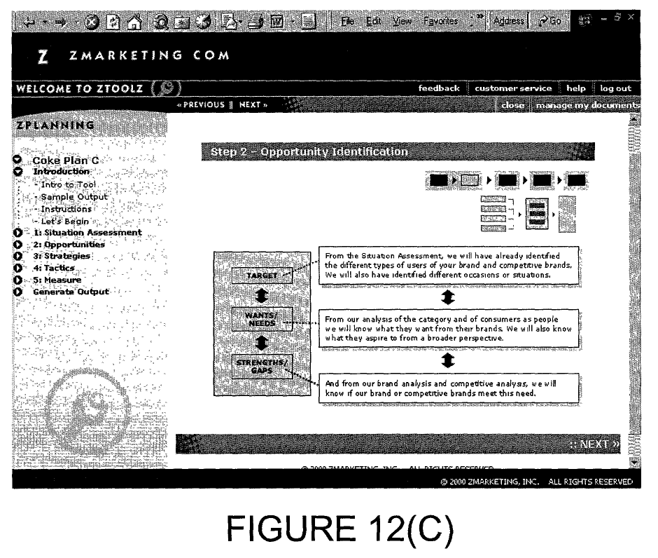

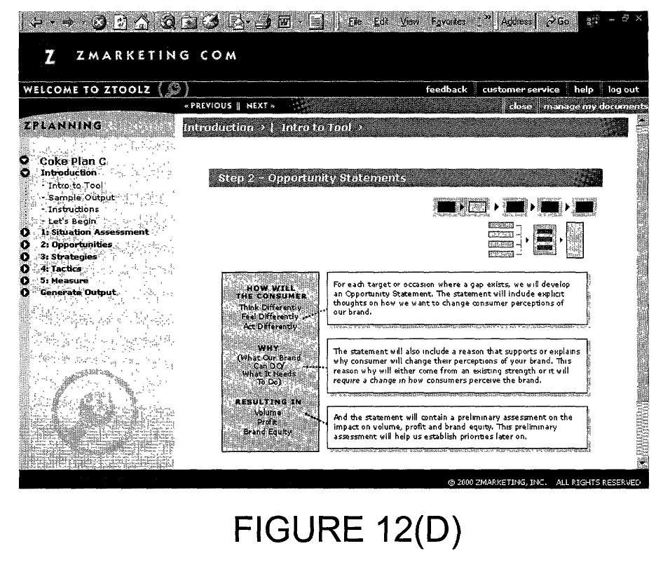

FIGS. 12(A) to 12(D) provide an overview of the second step within the planning tool, namely identifying opportunities. With reference to FIG. 12(B), the conclusions drawn from step 1 for both business, category, brand, and competitive assessments form the inputs into an opportunity identification analysis. The opportunity identification analysis prioritizes opportunities by evaluating targets, wants/needs, and strengths/gaps. As explained in more detail in FIG. 12(C), the target has already been identified from the situation assessment and the data gathered in the first step is pulled forward into questions within the second step of opportunity identification. As explained in FIG. 12(D), for each target or occasion where a gap exists, an opportunity statement is developed with this statement including reasons that support or explain why the consumer will change their perception of your brand and a preliminary assessment on the impact on volume, profit, and brand equity.

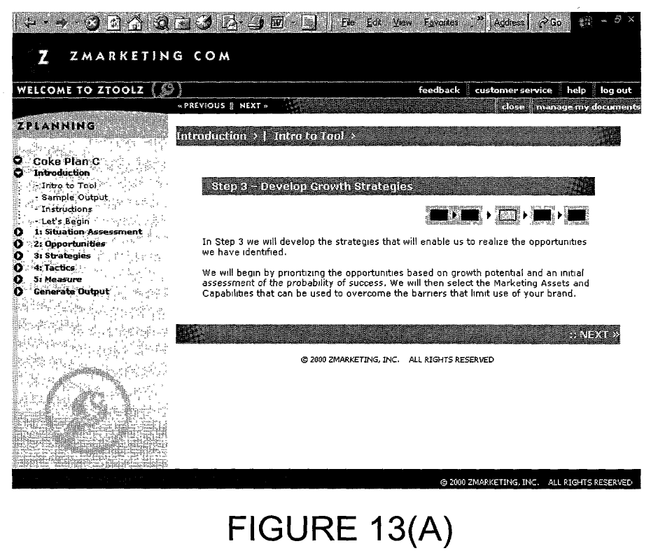

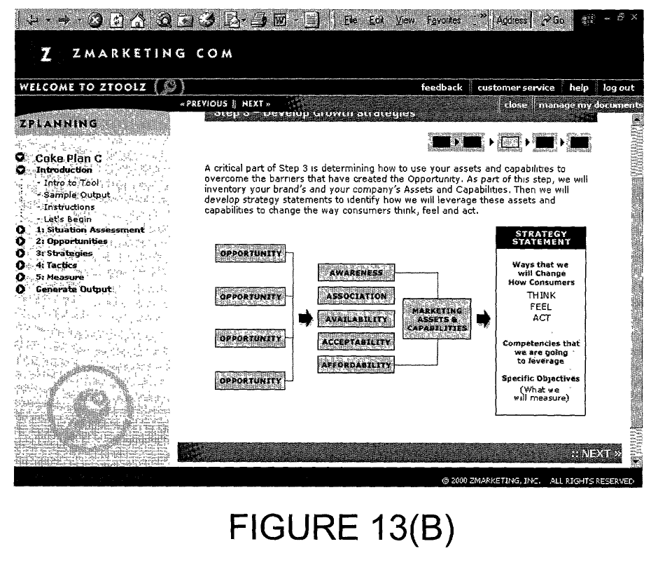

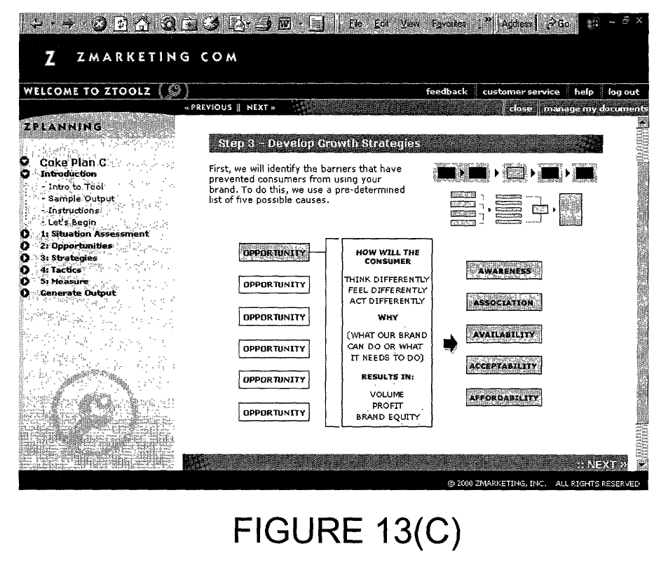

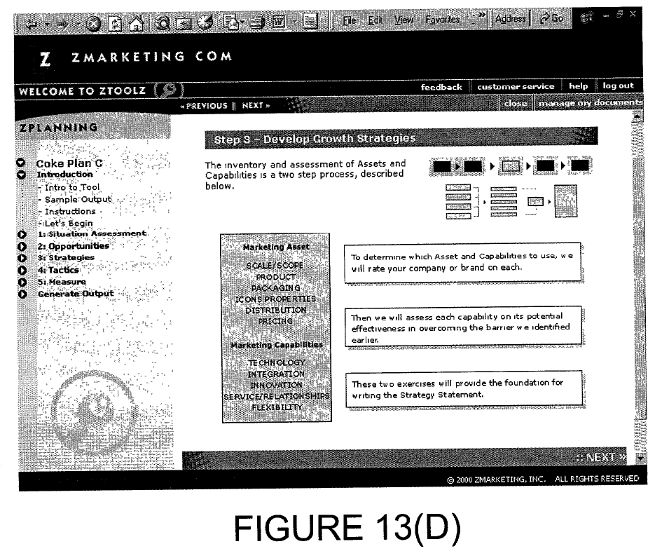

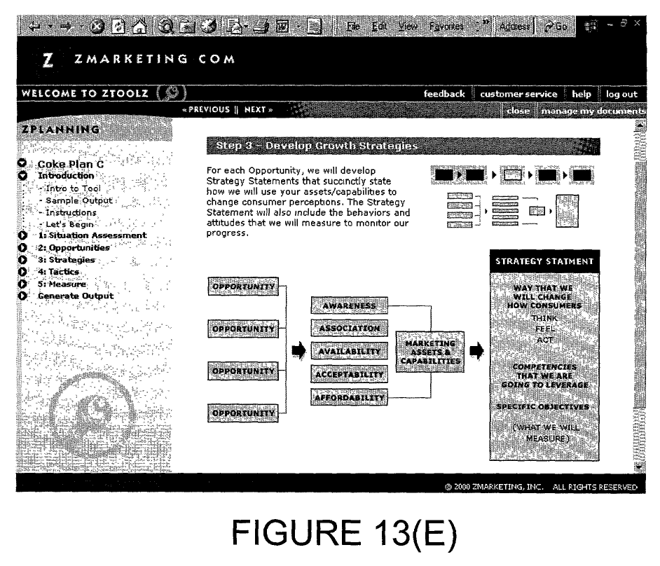

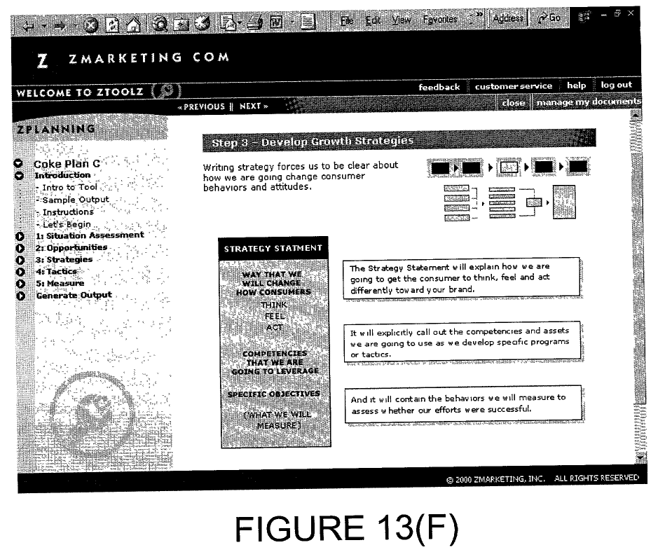

FIGS. 13(A) to 13(F) provide an overview of the third step involving developing growth strategies. FIG. 13(B) provides an overview of the process involved in developing growth strategies. This process involves taking each opportunity identified in the second step and determining how a company's assets and capabilities can overcome barriers for creating the opportunity. This process also involves taking an inventory of brands and companies assets and capabilities followed by developing strategy statements identifying how to leverage those assets and capabilities. FIG. 13(C) provides a more detailed explanation of identifying barriers, FIG. 13(D) shows in more detail the taking of inventory and assessment of assets and capabilities, FIG. 13(E) illustrates the development of strategy statements, and FIG. 13(F) explains advantages of using the processes within step 3.

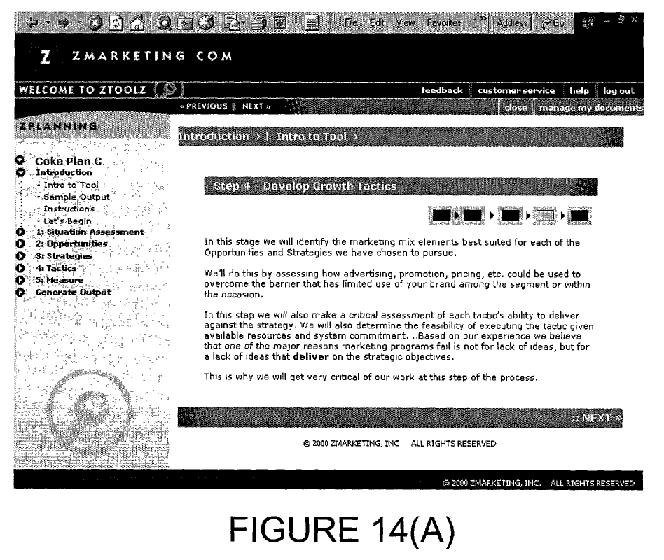

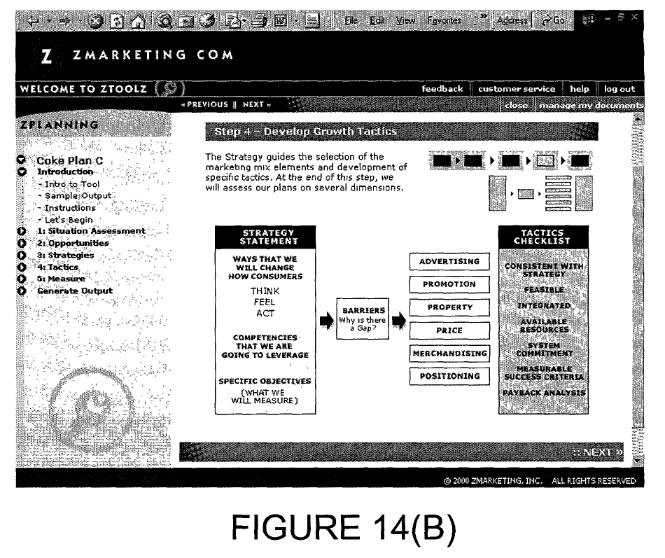

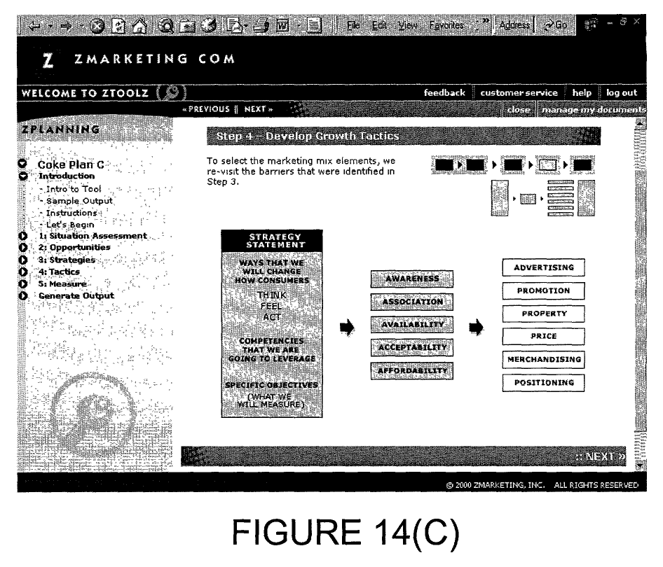

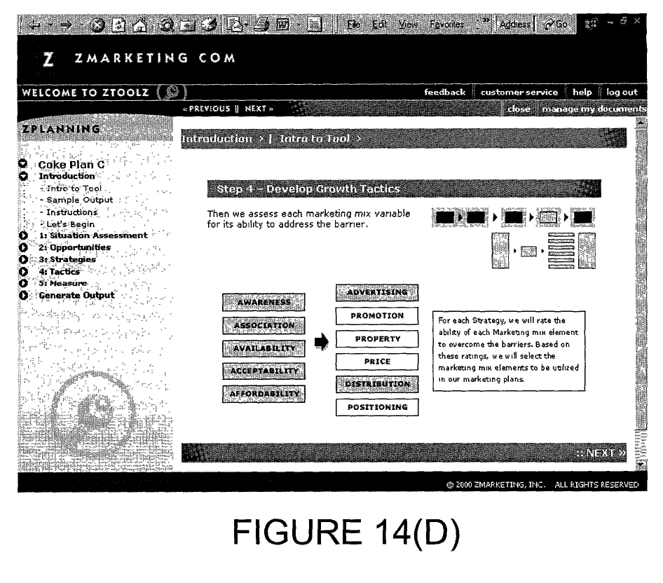

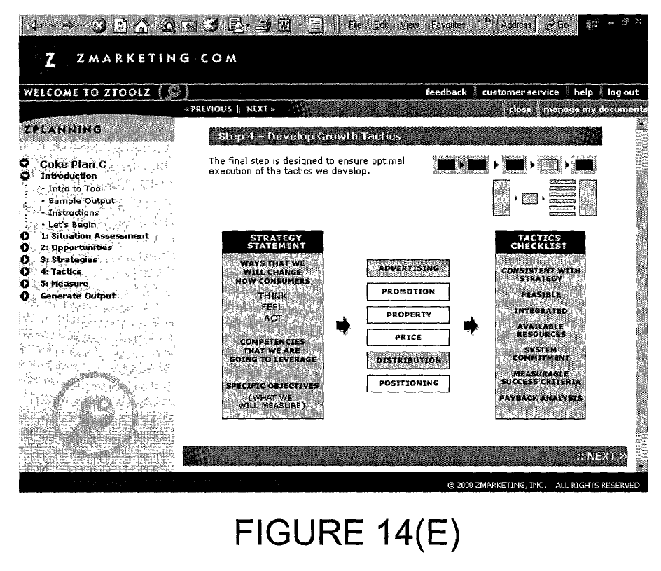

FIGS. 14(A) to 14(D) provide an overview of the fourth step of developing growth tactics. As depicted in FIG. 14(B), the strategy statement from step 3 guides in the selection of the marketing mix elements and development of specific tactics. Selecting the desired marketing mix elements involves revisiting barriers that were identified in step 3, as explained in FIG. 14(C). The process of developing growth tactics involves assessing each marketing mix variable for its ability to address the barrier and then ensuring optimal execution of the tactics.

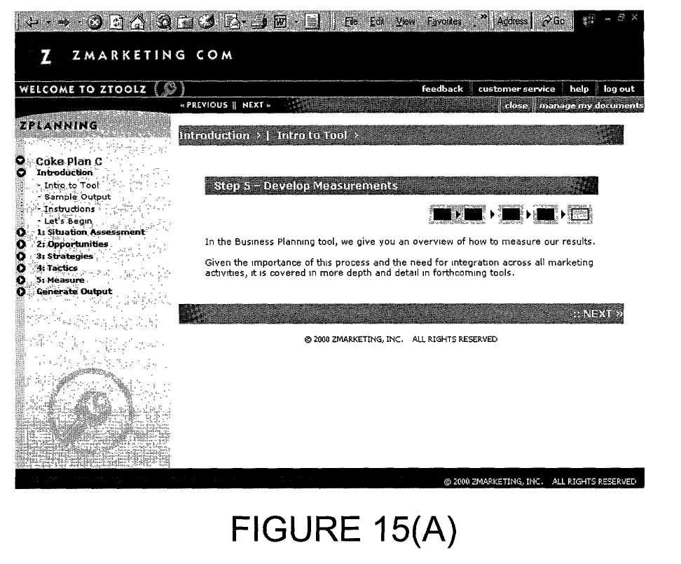

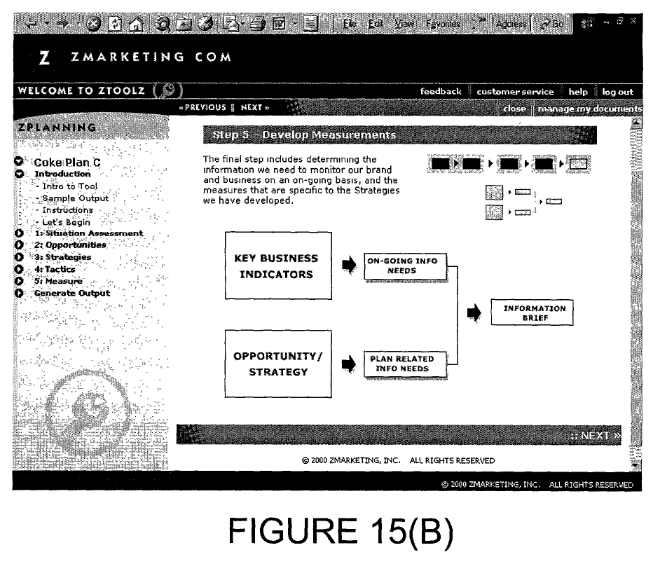

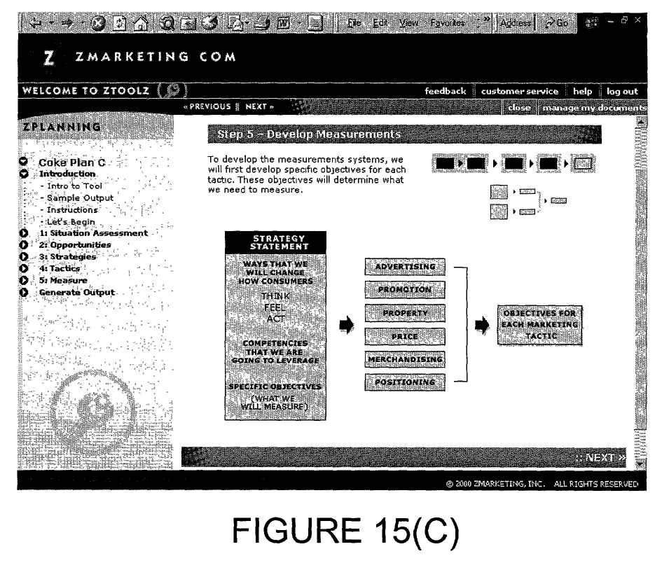

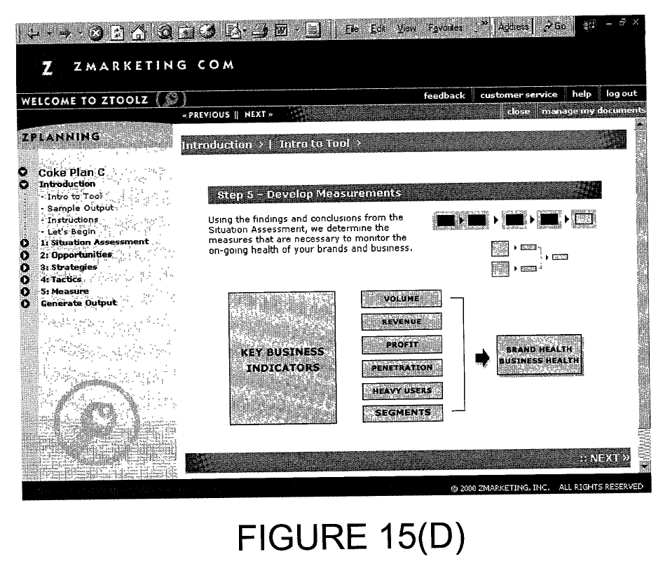

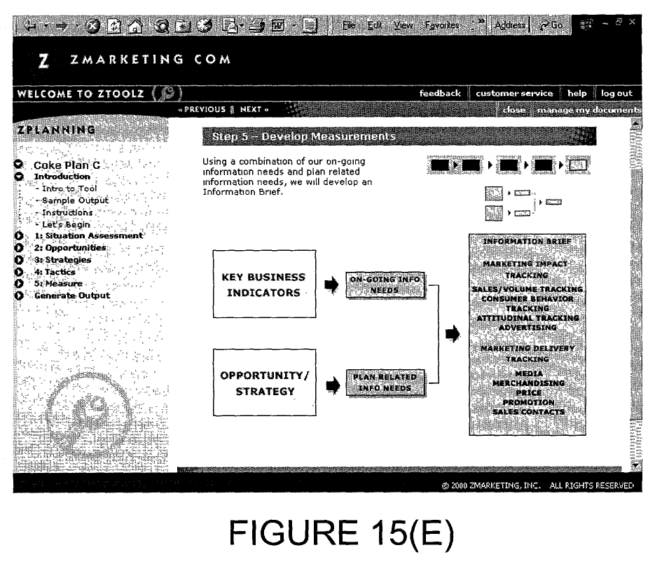

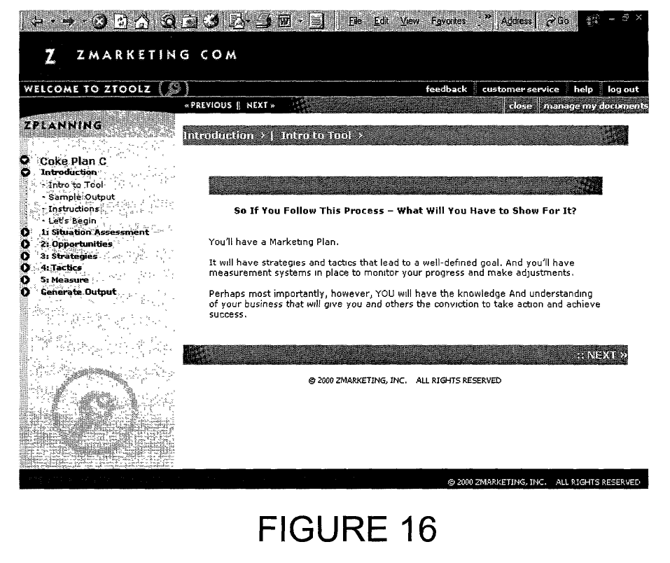

FIGS. 15(A) to 15(F) provide an introduction to the final step of the planning tool, namely developing measurements. This step involves first determining what information is needed to monitor a brand and business on an on-going basis and the measures that are specific to the strategies, as depicted in FIG. 15(B). As explained in FIG. 15(C), specific objectives are developed which determine what measurements must be made. With reference to FIG. 15(D), the findings and conclusions from the situation assessment is used in determining the measures that are necessary to monitor the on-going health of the brands and business. The outcome of the developing measurements step is an information brief, such as the one shown in FIG. 15(E). FIG. 16 is an example of an interface that explains the outcome of the entire tool.

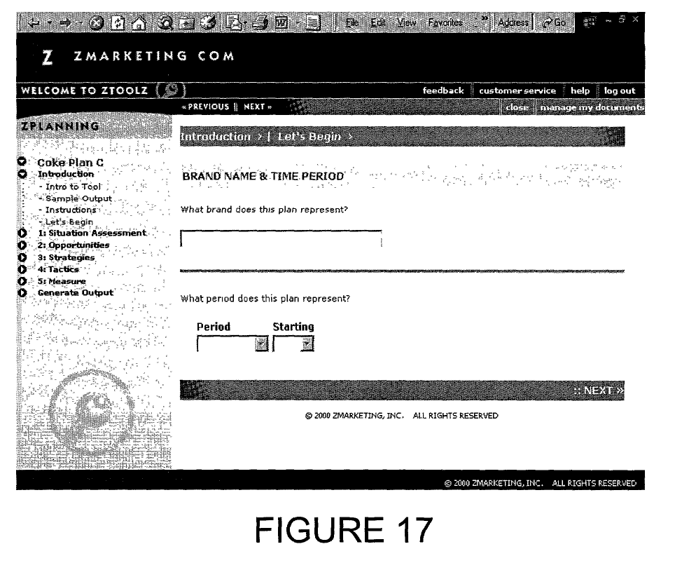

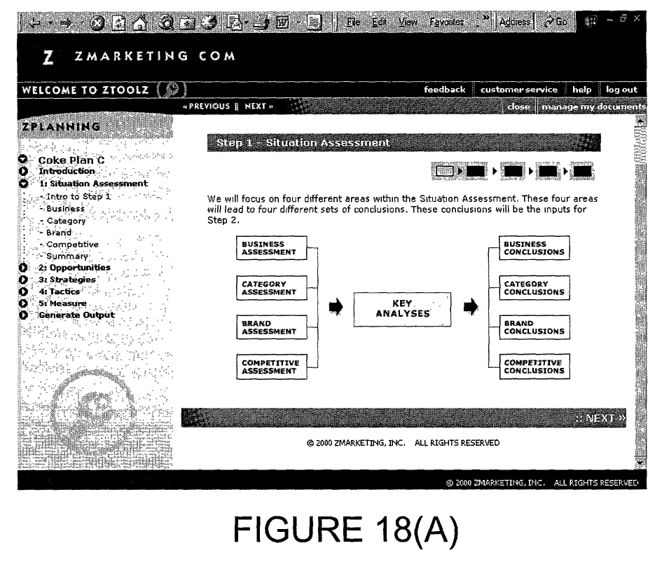

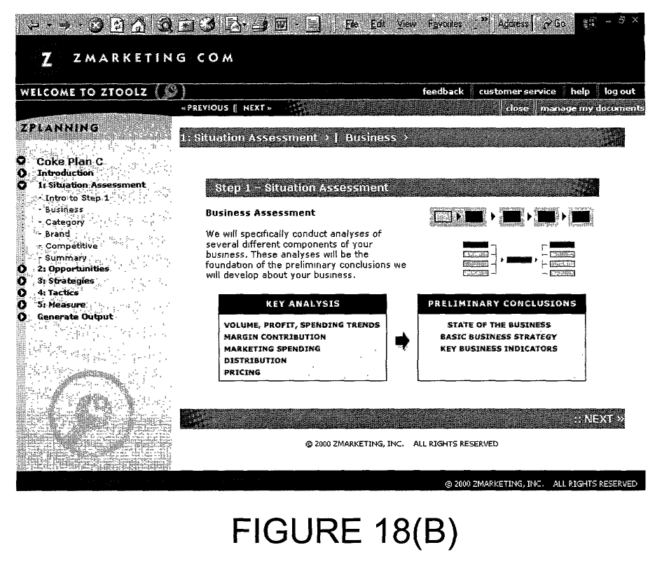

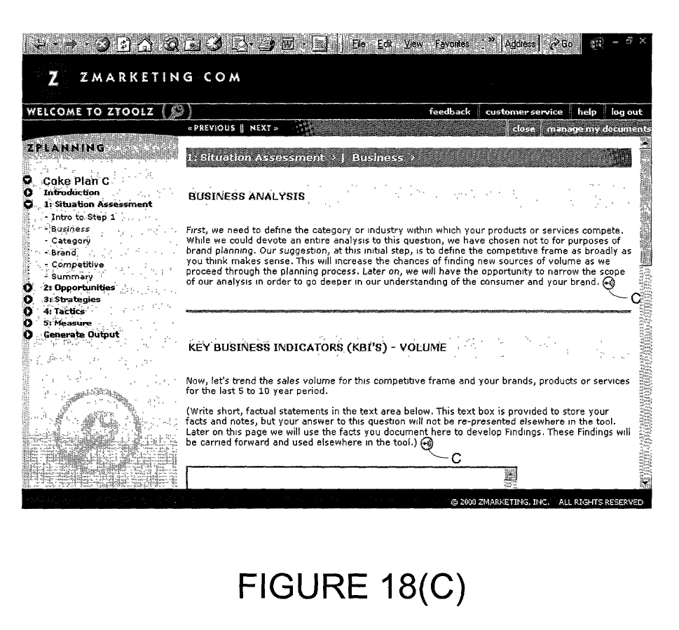

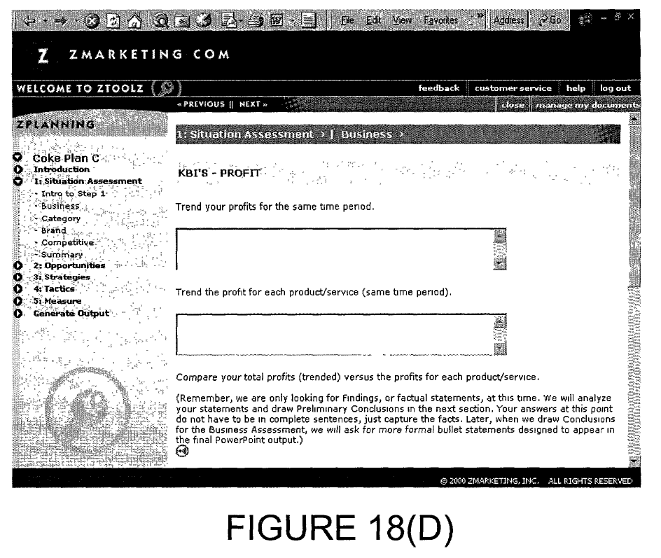

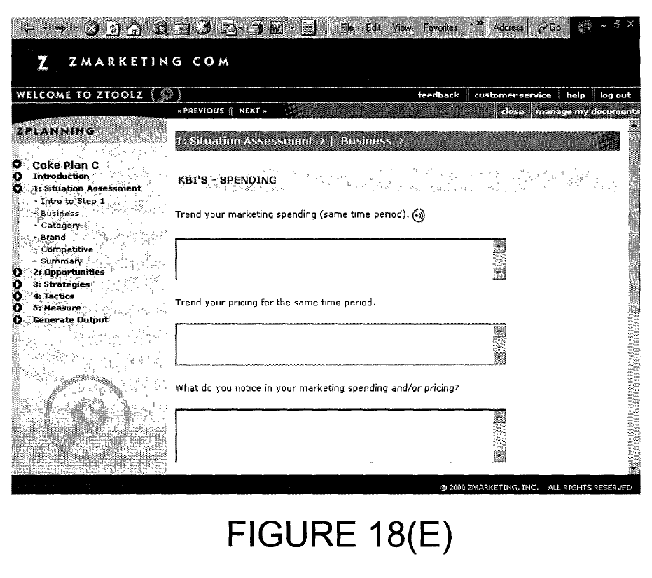

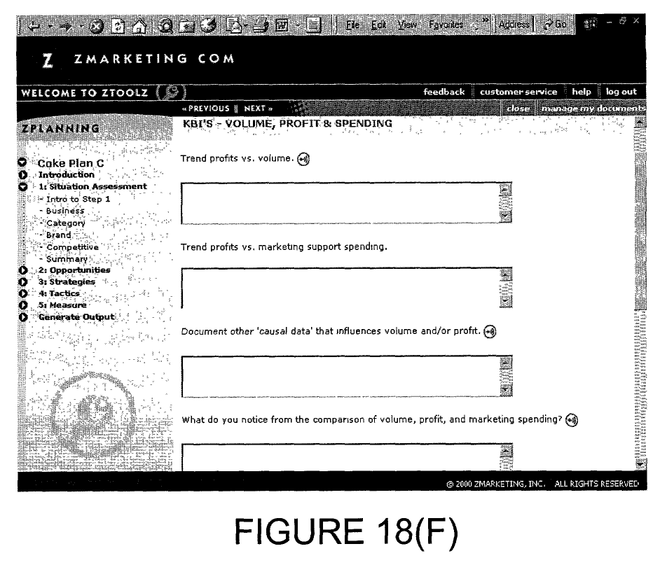

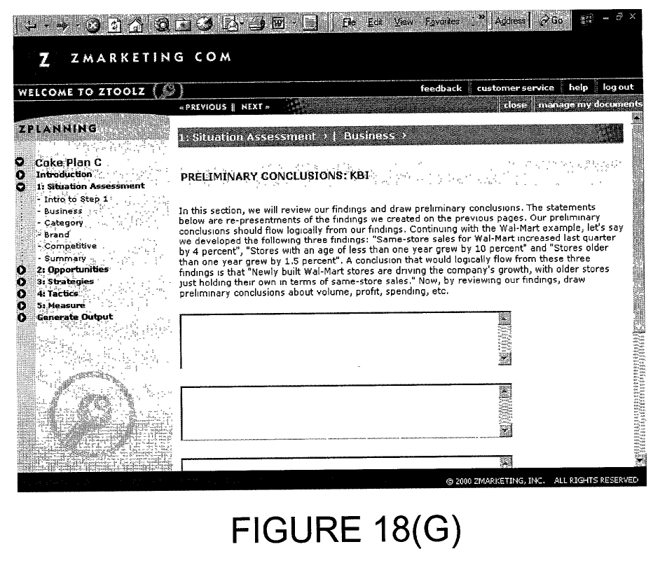

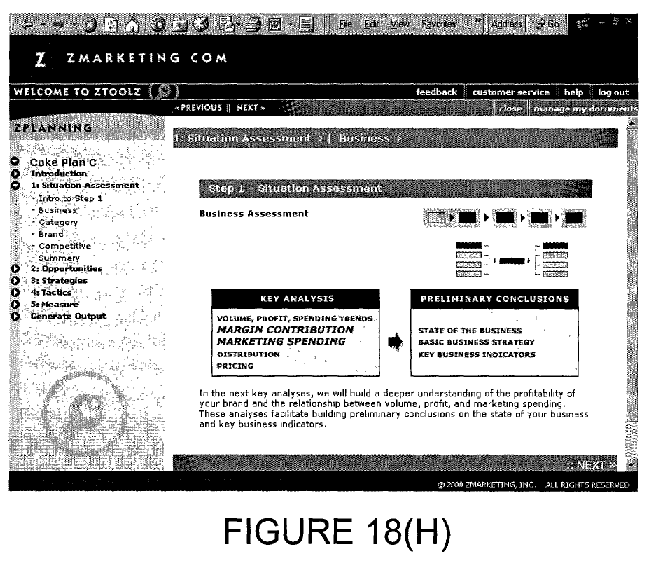

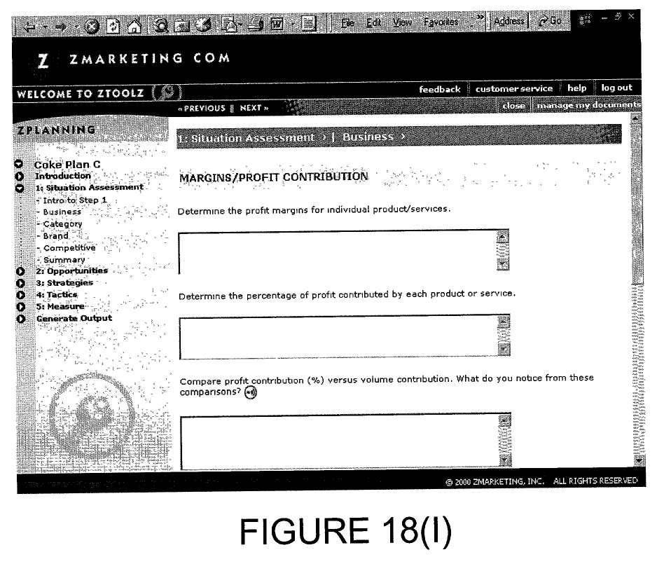

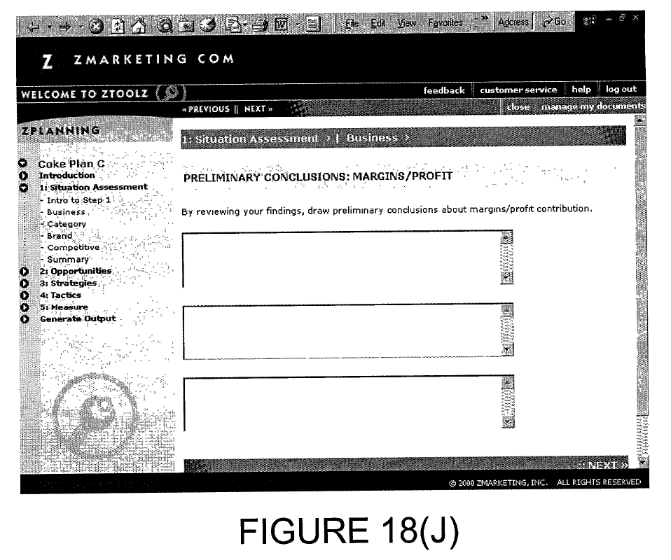

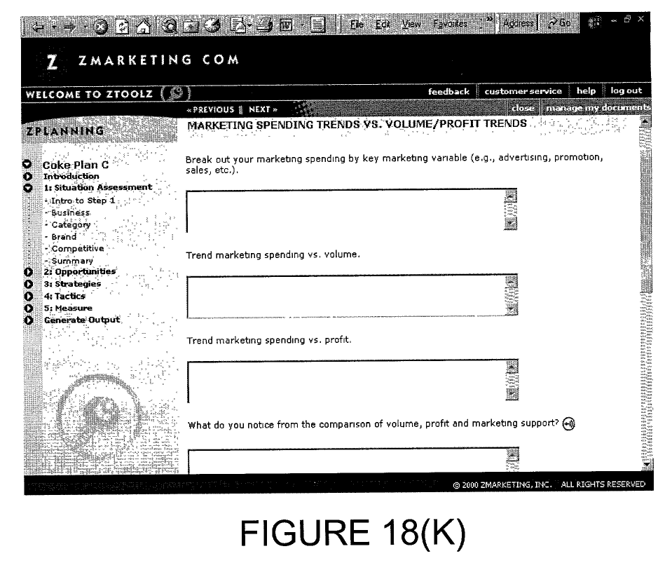

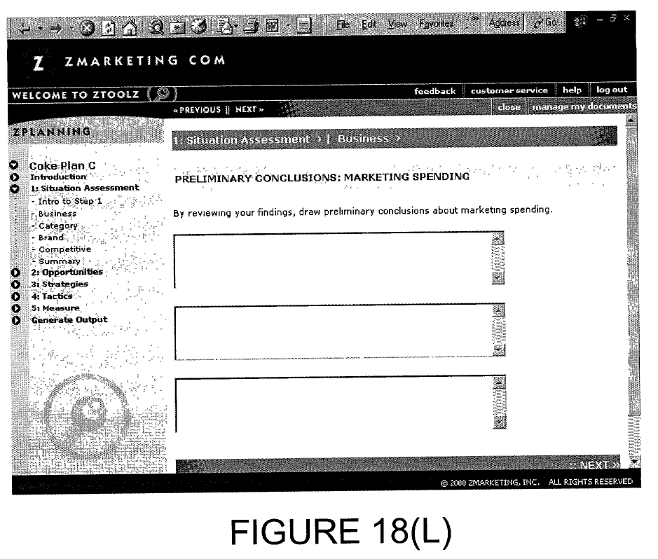

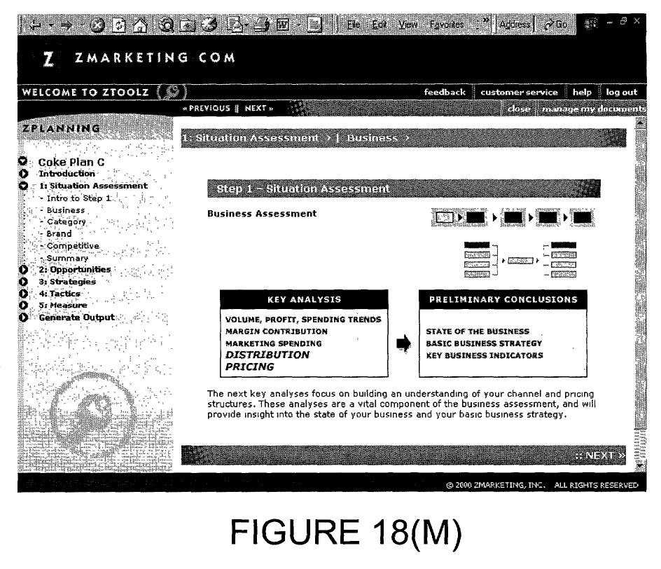

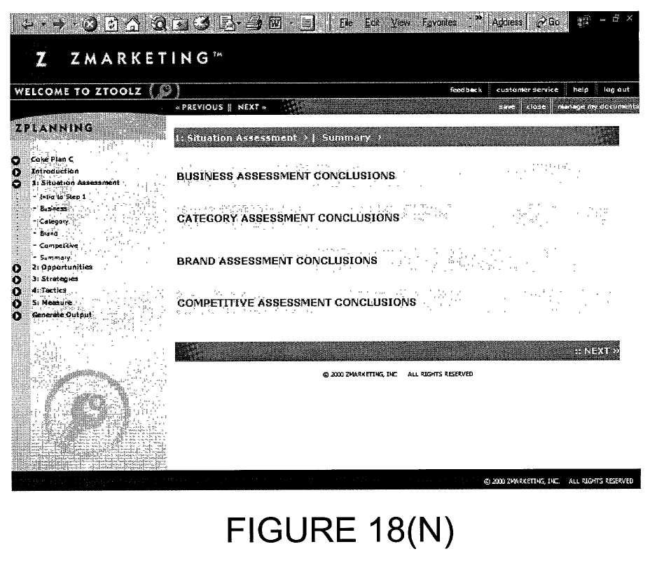

FIG. 17 provides an example of an interface for the beginning of the planning tool. As shown in this interface, a user enters the name of the brand and a time period associated with that brand. FIG. 18(A) provides an overview of the situation assessment step and FIG. 18(B) provides an overview for the first substep within situation assessment, namely business assessment. As mentioned above, each of the assessments within the situation assessment involve deriving preliminary conclusions from a set of questions and findings. FIGS. 18(C) to 18(E) provide examples of the question and answer format of the planning tool. As explained in FIG. 18(C), facts and other answers input by the user are used in subsequent parts of the tool in subsequent steps. In this figure, the facts presented in relation to volume of business are “carried forward and used elsewhere in the tool.” As also shown in FIG. 18(C), the tool provides explanations for each question and also provides conversation symbols C that allow the user to obtain more detailed explanations and possibly sample answers to a particular question. FIG. 18(G) provides an example interface through which users begin to formulate preliminary conclusions for business assessment. FIGS. 18(H) to 18(N) provide examples of other interfaces through which marketing professionals answer questions, obtain findings, and draw preliminary conclusions. FIG. 18(N) is an interface through which the planning tool provides a summary of all of the conclusions.

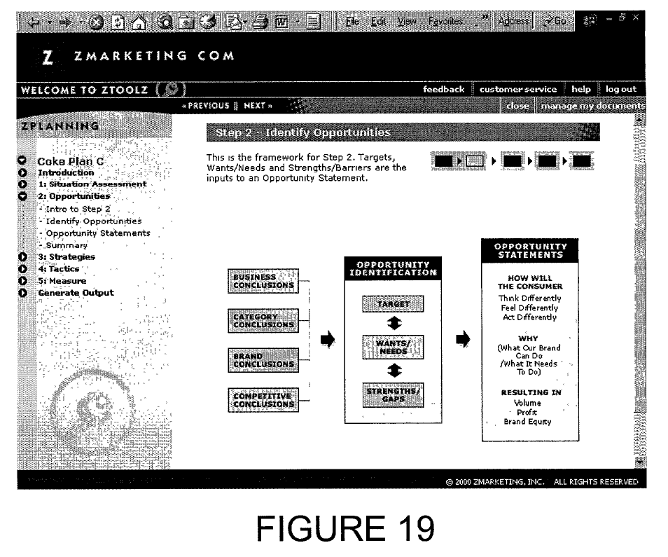

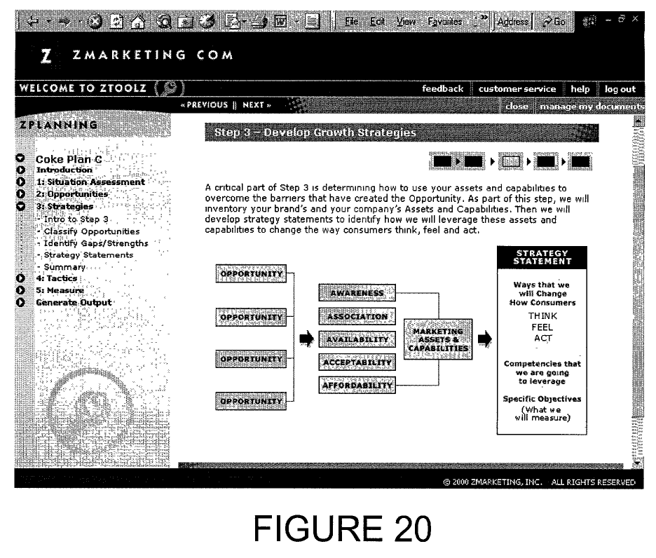

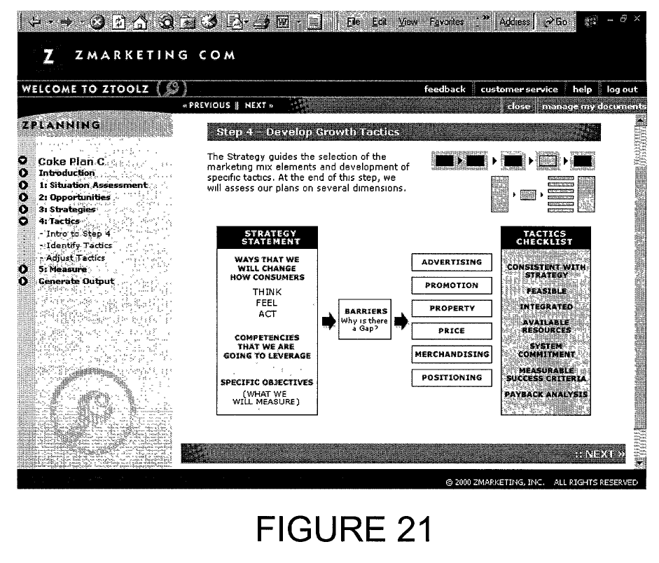

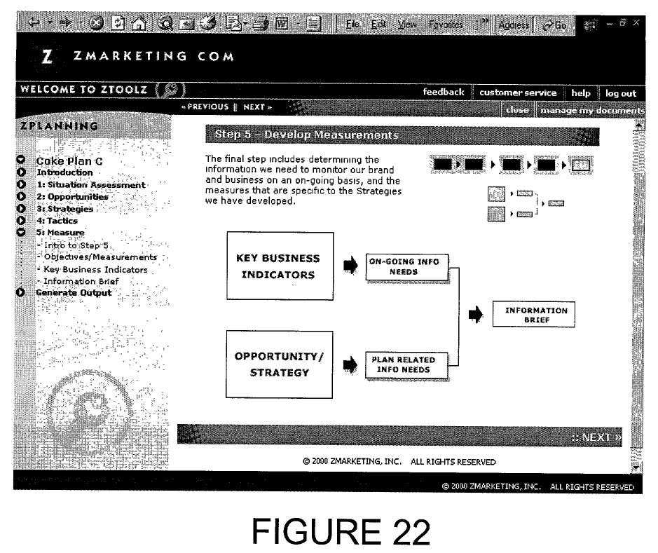

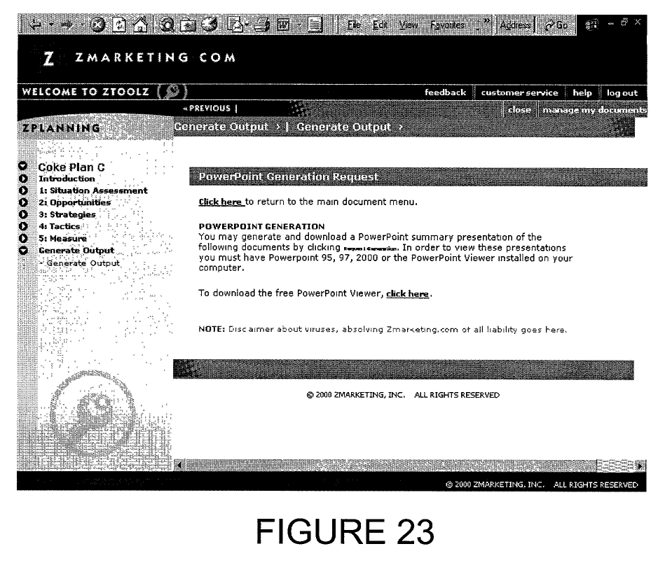

As mentioned above, the outputs of each step are used as inputs to the subsequent step. FIG. 19 explains how the business conclusions form the inputs to opportunity identification in generating opportunity statements. FIG. 20 illustrates how growth strategies are developed by determining how assets and capabilities can be used to overcome barriers created with the opportunities. FIG. 21 illustrates how the strategy statement form a part of the growth strategy is then analyzed in developing growth tactics. FIG. 22 is an illustration on how measures are developed specific to the previously developed strategies. Finally, FIG. 23 provides an example of an interface presenting the output of the tool.

V. Personalized Tools

A. Personalized Features

The tools according to the invention preferably are personalized to the answers provided by the marketing professional. This personalization is accomplished through several aspects of the tool. For example, according to one aspect, answers provided by a marketing professional dictate what subsequent questions will be provided to the marketing professional. In this way, the marketing professional need not waste time answering additional questions and going through additional interfaces when those questions and interfaces are inapplicable. This feature makes the tools more streamlined and efficient to use. According to another aspect, answers and other input provided by marketing professionals are carried forward to subsequent questions. This feature makes the tools responsive to the input and again makes the tool more personalized and relevant to the marketing professional.

As mentioned above, when navigating through a tool, a user “conditionally” proceeds to the next or previous page based on input given in the current page. For example, a page has been designed to “feed”0 off of answers of previously asked questions. If the user did not answer previously asked questions, there would be no need to display the page. To configure conditional navigation, each page is considered a node and relationships are defined between the nodes. For example, one page has a NodeShowRelated “child” record with a TreeNodeID of a record in a TreeNode table and a RelatedTreeNodeID for the previously asked question. A NodeCondition “child” record is added for the TreeNodeID of record in the TreeNode table when a user selects the Next or Previous page, the tool retrieves the next TreeNodeID if next is selected and evaluates the page's child record is previous is selected.

B. Platform

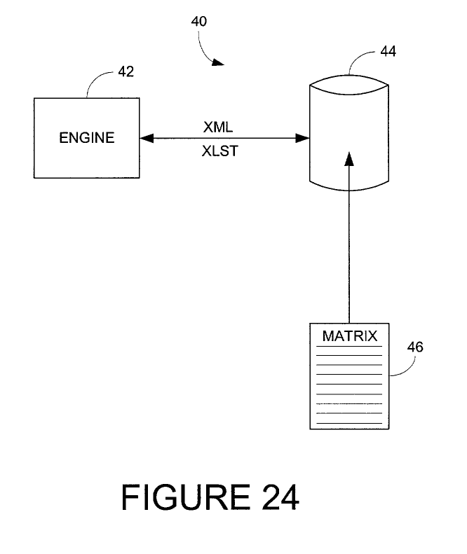

A partial diagram of a platform 40 for allowing personalization of the tools will now be described with reference to FIG. 24. The platform 40 includes an engine 42 and a database 44 which contains a matrix 46. The engine allows for the addition of more tools and allows for intricate and highly complex questions. The engine 42 also produces a simple and intuitive interface. The engine 42 combines data from the database 44 and user data to produce an XML document. The engine 42 executes the tool logic to create the XML document and then processes the XML to produce an intuitive user interface. As shown in FIG. 24, the database 44 contains a matrix 46 which is used to specify the logic of the tools. Because the logic is contained within the database 44 within the matrix 46, the logic can be easily modified to create new tools or to alter existing tools. The platform 40 therefore provides a framework which can be easily maintained and supported with minimal effort.

An explanation will now be given on a preferred matrix 46 used within the platform 40. The matrix includes tables for matrix, matrix cell, node interpretation, node condition, formula, formula math token, tool pick list, and tool pick list item. A method of loading a tools matrix resource will now be described, a first step involves defining horizontal and vertical dimensions. For this procedure, the matrix is considered to be a grid of cells with horizontal column headers and vertical row headers.

A method will now be described of a loading tools matrix resource procedure. A first step involves defining horizontal and vertical dimensions. For this procedure, the matrix is considered to be a grid of cells with horizontal column headers and vertical row headers. Each of the two sets of headers are pick lists and two new pick list table records are created for these pick lists. A second step involves populating the pick list items. At this step, records are added to the pick list item table to define pick list items for both of the newly added pick list records. Next, a new row is added to the matrix table with values to identify the matrix. Next, cells of the matrix are created, which involves adding multiple rows to the matrix cell table. The next step involves creating recommendations, which involves adding multiple rows to a node interpretation table. Next, multiple rows are added to the node condition table. For each node interpretation row added, some conditions may be added. For example, “Price Offers” recommendation may have three conditions that have “and” connectors. The next step involves using a formula and formula math token tables to enter formulas entered by the Node Condition records. Finally, for each of the formulas added, records are entered to make up the pieces of the formula.

As an example, defining the horizontal and vertical dimensions may involve a pick list name of “promotional strategies/objections” and other dimensions, such as promotional tactics. Populating the pick list items includes entering text that will be displayed in the tool for a particular pick list item. In creating a matrix, a name may be entered for the matrix, such as “Matching Consumer Promotion Tactics to Promotion Strategies.” The cells of the matrix are then created for each possible combination of tool pick list items. For example, if a horizontal tool pick list has eleven items and a vertical tool pick list has twelve entries, a matrix of one hundred thirty two matrix cell child rows are possible. Creating recommendations involves selecting a particular tree node to include recommendations, adding text, image files, and optional style sheets.

VI. Marketing Investment Manager

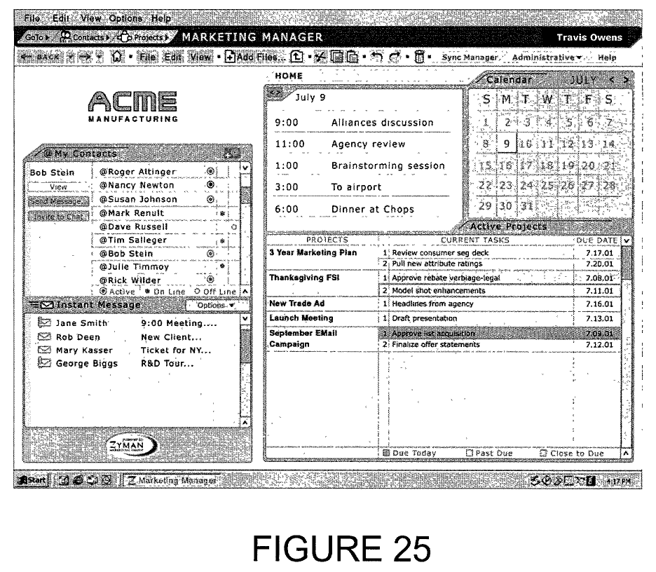

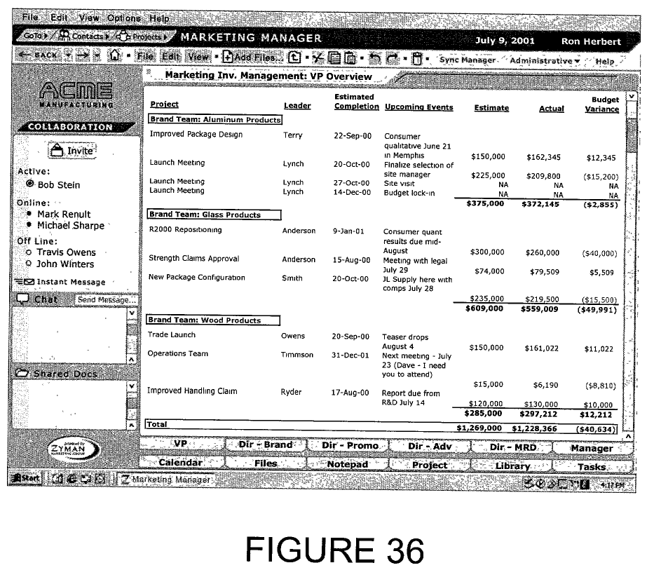

The marketing tools described above preferably form part of an entire marketing solution for an entity. FIG. 36 illustrates a main interface presented to a user through this marketing solution. For the purposes of this description, the marketing solution will be referenced as a marketing investment manager although other names such as enterprise marketing manager, marketing automation, marketing resource management, or marketing enterprise solution are equally applicable. As shown in FIG. 25, the marketing investment manager provides functionality to the marketing professional to assist him or her in performing his or her job. The marketing investment manager provides contact information for individuals that the professional needs to communicate with on a particular project or group of projects. The marketing investment manager also includes a calendar function whereby the marketing professional can track deadlines and important dates. The marketing investment manager also includes a list of projects and also provides the ability to send messages to those within the contacts.

In the preferred embodiment, the marketing investment manager is part of a combined client-server and distributed network. As shown in the contacts portion of the interface, the marketing investment manager can determine which of the people within contacts is active, on-line, or off-line and indicate the status appropriately. As will be apparent from the description below, the ability to operate in a distributed network has advantages in fostering team work, efficiencies in real-time collaboration, while at the same time allowing marketing professionals to work outside of the network. While in the preferred embodiment the marketing investment manager forms part of a distributed network, it should be understood that the marketing investment manager may in other embodiments be part of a local area network or other type of network.

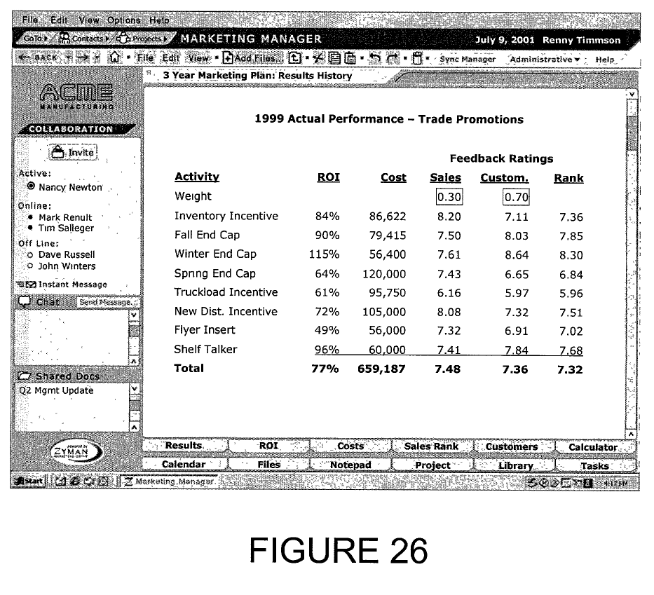

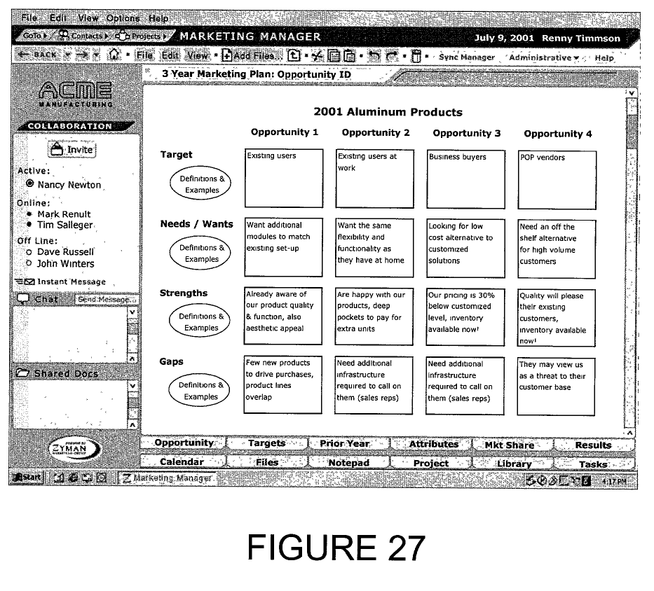

The interface shown in FIG. 25 is a main interface for a marketing professional. The interface is intended to highlight information that is of relevance to a particular marketing professional, such as that person's contact information, projects, and calendar. Some additional functionality provided by the marketing investment manager will now be described with reference to FIGS. 26 to 36. As mentioned above, FIG. 25 provides a list of projects associated with a particular marketing professional. The first project is a 3 Year Marketing Plan and, upon selecting this project, the professional can receive the interface shown in FIG. 26. As shown in this figure, the marketing investment manager identifies people associated with that project and also whether or not those people are active, on-line, or off-line. The marketing investment manager also provides the ability to chat in real-time with those individuals and to share documents. For each project, a set of tabs is provided for functionality common to all projects. In this example, these tabs include a Calendar function associated with that project, Files associated with that project, a Notepad, a Project tab, a Library of resources, and Tasks all of which are associated with that project. Each project also includes a set of tabs relevant to that particular project. For example, for the 3 Year Marketing Plan, a marketing professional has tools available to analyze Results, ROI, Costs, Sales Rank, Customers, and a Calculator. FIG. 26 illustrates the Results History for the 3 Year Marketing Plan. FIG. 27 illustrates an example of the planning tool used in conjunction with the marketing investment manager. In this interface, the marketing professional is going through the step of identifying opportunities.

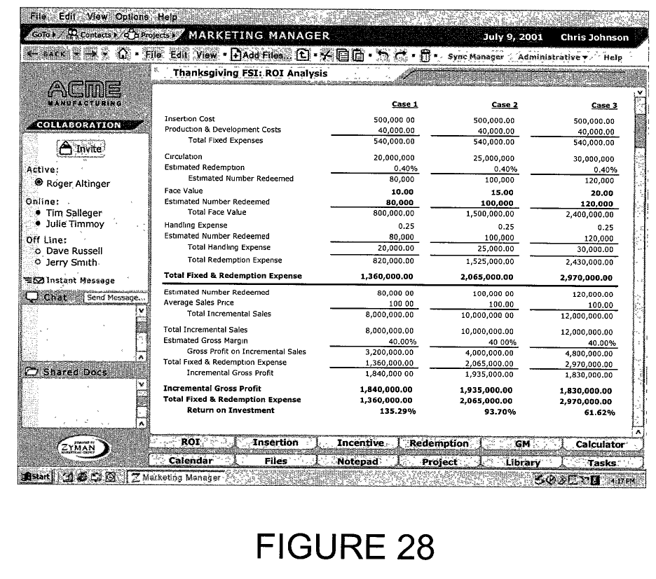

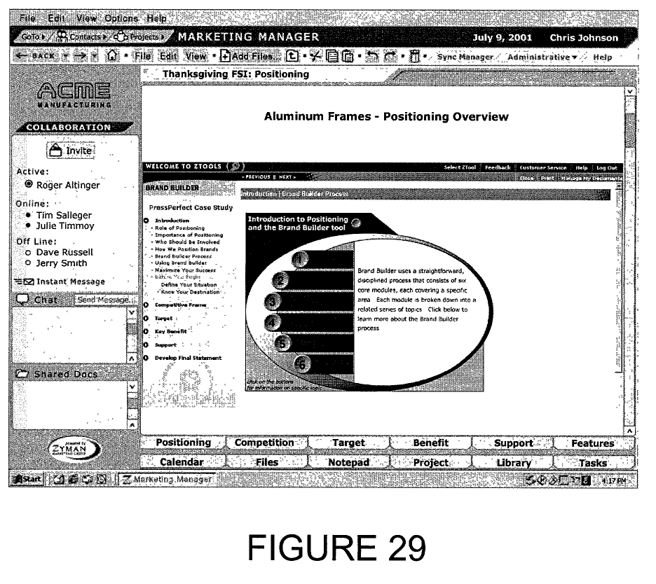

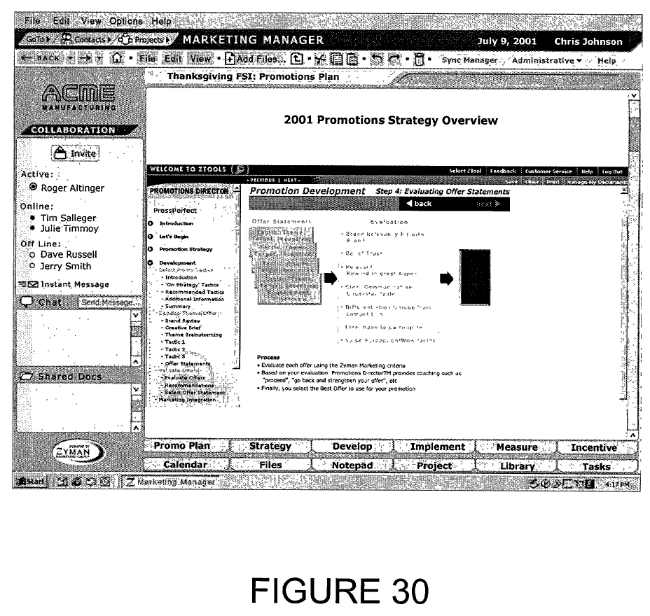

Another project shown in FIG. 25 is a Thanksgiving Free-Standing Insert (FSI). FIG. 28 illustrates an interface to the marketing investment manager with a ROI tool activated. As shown in this Figure, a marketing professional can run scenarios on the FSI, such as comparing circulations of twenty million, twenty-five million, and thirty million with different face values. From these scenarios, the marketing professional can maximize the ROI. As shown in this figure, the tabs for the ROI analysis are different than that for the Planning tool and also for the Results History tool. FIG. 29 is an example of an interface to the marketing investment manager with a positioning tool activated. As shown in the figure, the positioning tool, also called brand builder, includes core modules covering competitive frame, target, key benefit, support, and statements. The tabs in FIG. 29 include links to each of those core modules. An outcome of the brand builder tool may be provided as an input to other tools, such as a promotions tool. FIG. 30 illustrates an example of a promotions tool activated within the marketing investment manager. As is apparent from a comparison of FIGS. 27 and 28, the contact people associated with the Thanksgiving FSI are unique to that project and differ from those associated with the 3 Year Marketing Plan project.

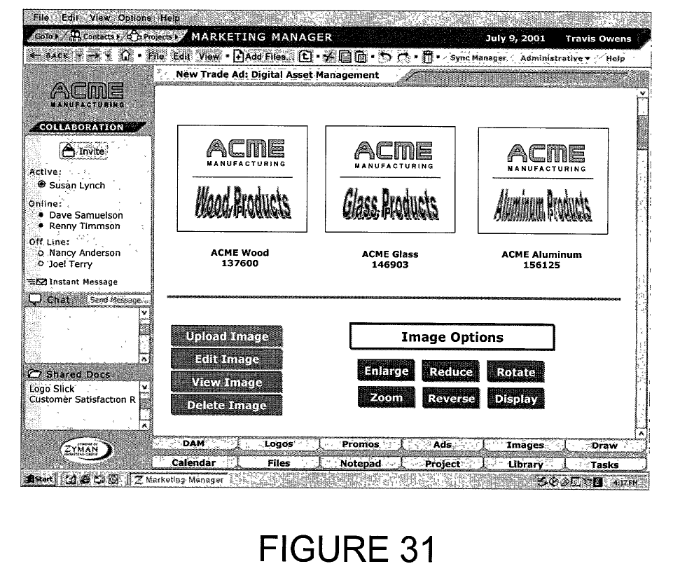

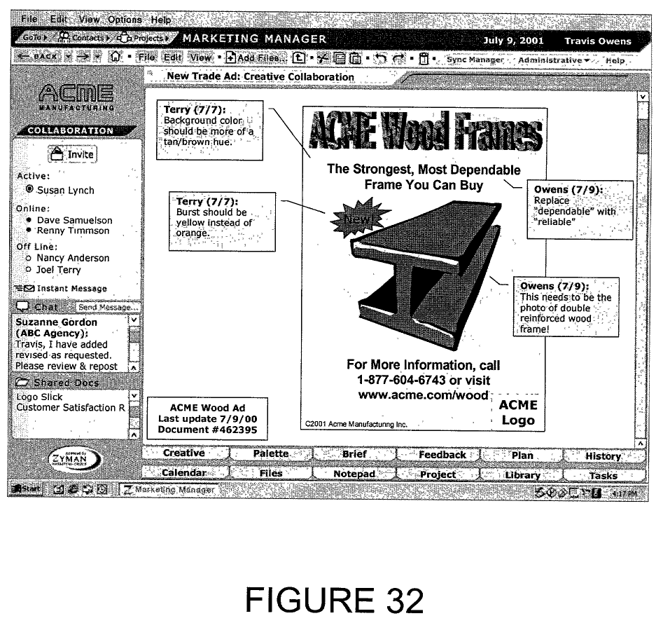

A third project listed in FIG. 25 is a New Trade Ad. FIG. 31 is an interface to the marketing investment manager which highlights digital asset management functionality. As shown in this figure, the marketing investment manager allows a marketing professional and entity to manage all of the digital assets associated with a project. For example, a marketing professional can upload, edit, view, and delete images associated with a particular project. These assets include logos, promotions, advertisements, and other images. FIG. 32 illustrates the collaborative functionality provided by the marketing investment manager. With the new Trade Ad project, as shown in FIG. 32, a marketing professional can design an advertisement and obtain feedback from all relevant people in real-time in a collaborative environment. For example, an advertising agency, print company, company representative, or other entities can insert comments into the collaborative window which will be shared with all other users. Individuals can also insert comments into the instant messaging function, such as those shown in the figure which are provided by Suzanne Gordon.

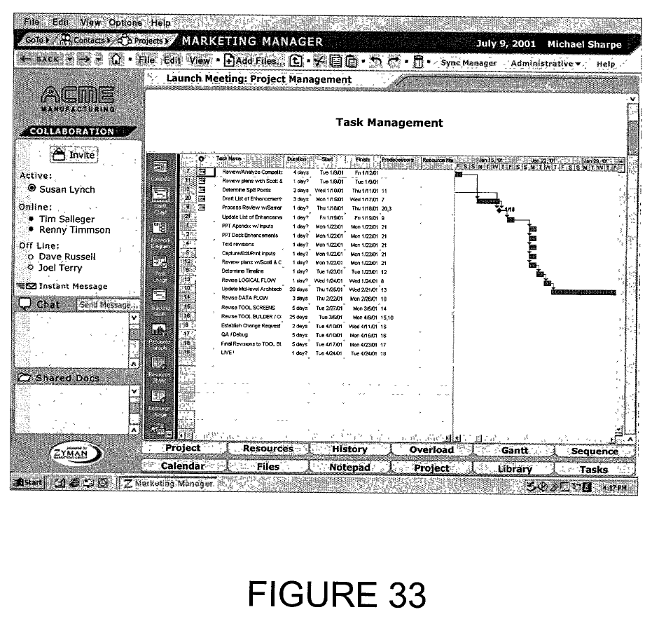

A fourth project listed in the interface of FIG. 25 is a Launch Meeting project. FIG. 33 highlights some project management functionality provided by the marketing investment manager. Through this project management functionality, users can manage tasks associated with a project, such as the duration, start and finish times, and ensure predecessor tasks are completed in a timely fashion. The project management functionality provides a calendar function, Gant chart, Network Diagram, Task Usage, Tracking Gant, Resource Graph, Resource Sheet, and Resource Usage functionality.

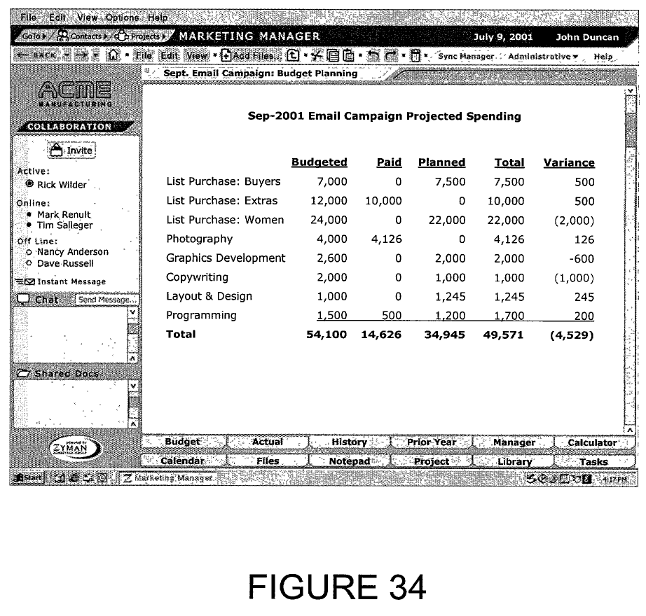

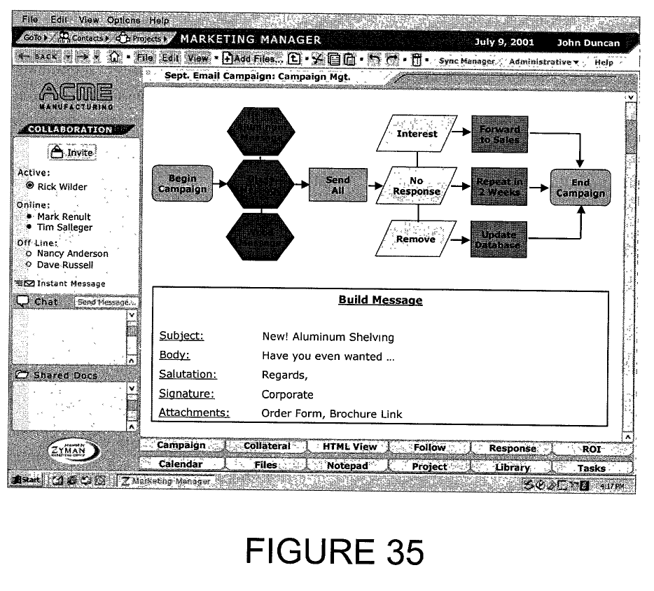

A September EMail campaign is the last project mentioned in FIG. 25. FIG. 34 provides an example of an interface to the marketing investment manager highlighting a budget tool. One of the options available to a user through the interface of FIG. 34 is a manager tab for allowing the user to actually manage an EMail campaign. FIG. 35 provides an example of an interface for campaign management and allows a user to build messages forming part of the EMail campaign. As part of the campaign management aspect of this tool, professionals can review, reply, forward responses and manually or automatically analyze the ROI.

The interfaces shown in connection with FIGS. 25 to 35 are generally geared toward a marketing professional who is involved in one or more projects. These interfaces depict how the marketing investment manager can assist the marketing professional in collaborating with others on a project, in managing projects, in communicating with others associated with a project, in completing tasks through one or more tools provided by the marketing investment manager, and in managing digital assets of an entity. The marketing investment manager is also useful for more upper level management in assisting them in their management of multiple projects or teams. FIG. 36 is an example of an interface for marketing investment management and shows a VP Overview. As shown in this Figure, a manager can obtain summary information on projects, such as leaders, estimated completion, upcoming events, cost estimates, actual cost, and budget variances. This interface also provides totals across projects, whereby a manager can obtain quick and accurate summary information on all projects and personnel under their supervision. Because all of the projects are managed and controlled by others within a project team, the data for providing the summary information is already entered into the marketing investment manager. The manager therefore need not actively input data into the marketing investment manager but instead can use the marketing investment manager as a source of information. As shown in the tabs in FIG. 36, the marketing investment management aspect of the marketing investment manager allows for summary information to be provided for particular managers, different divisions or directors, such as for brands, promotions, advertisements, or marketing research, or across all groups.

In general, the marketing investment manager provides processes and framework to enhance the ability to plan, manage, and drive marketing and product development programs. The marketing investment manager provides assistance in strategy, marketing supply chain, collaboration, product life cycle management, and digital asset management. Through the marketing investment manager, professionals can work smarter and deliver effective initiatives more quickly. The marketing investment manager also is more effective at managing spending, thereby decreasing logistic and material costs and helping professionals make better spending decisions. The marketing investment manager reduces time to bring new ideas to market allowing an entity to become more consumer-focused. The marketing investment manager also allows an entity to analyze the ROI on marketing dollars invested.

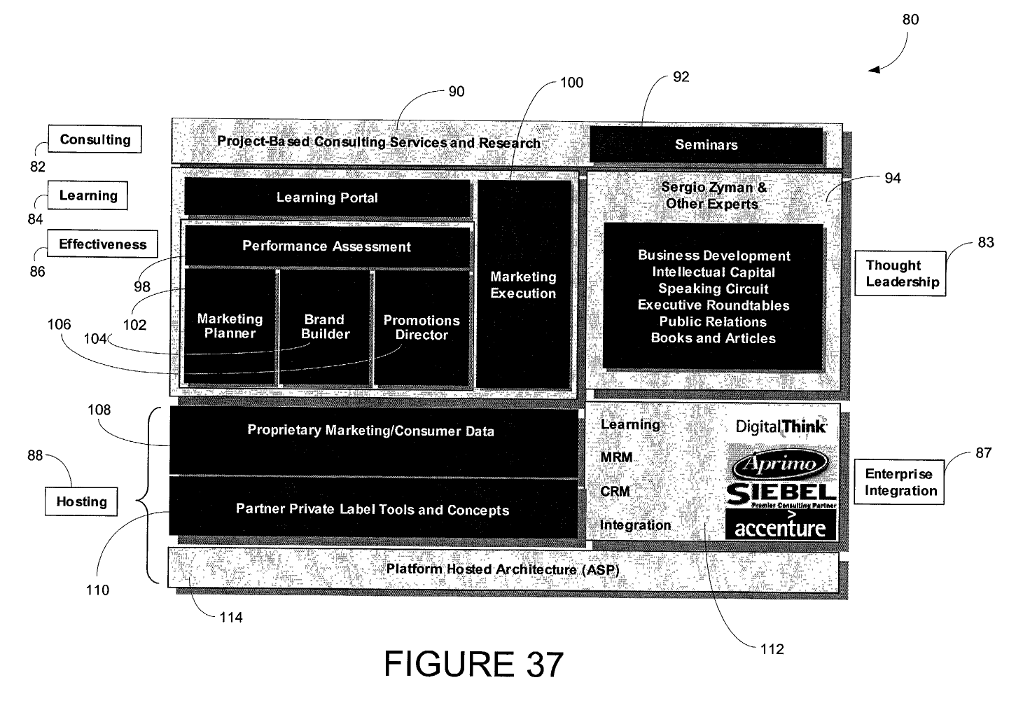

A diagram of a marketing investment manager solution is shown in FIG. 37. The solution 80 combines consulting 82 services, such as those provided by Sergio Zyman and Zyman Marketing Group with learning 84 resources and thought leadership 83. The solution 80 also provides effectiveness 86, enterprise integration 87, and hosting 88. In more detail, the consulting 82 includes not only project-based consulting services and research 90 but also seminars 92. The learning 84 can be provided though a learning portal 96, such as one available through ZMarketing.com. Thought leadership 83 can be provided by Sergio Zyman and other experts 94 in the areas such as business development, intellectual capital, speaking circuit, executive roundtables, public relations, and books and articles. The effectiveness 86 of the solution 80 stems in large part through tools provided by the marketing investment manager. The effectiveness 86 includes abilities in performance assessment 98, marketing execution 100, marketing planner 102, brand builder 104, and promotions director 106. With regard to enterprise integration, the solution 80 can adopt existing platforms and systems, such as learning from Digital Think of San Francisco, Calif., marketing resource management from Aprimo, Inc. of Indianapolis, Ind., customer relationship management from Siebel Systems, Inc. of San Mateo, Calif., and integration from Accenture of New York. Hosting 88 involves not only proprietary marketing/consumer data 108 but also partner private label tools and concepts 110. The entire solution 80 may be provided on a platform hosted architecture, such as an ASP 114. The solution 80 is not limited to the ASP model but also may be adopted in a LAN, WAN, and/or distributed network.

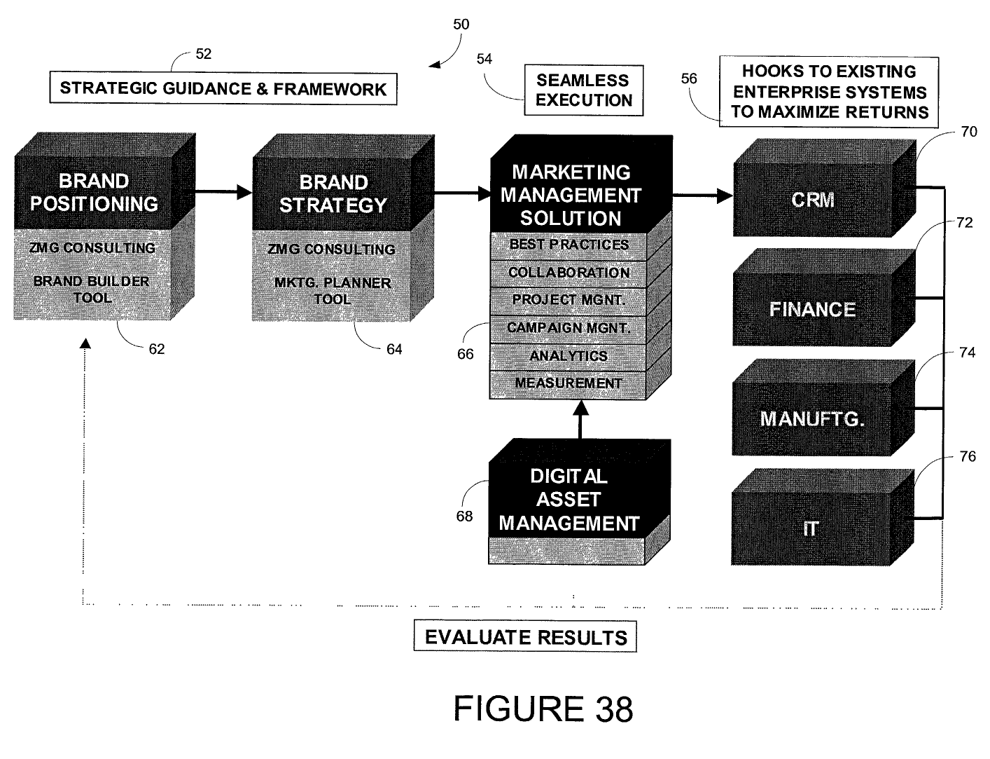

An example of a marketing investment manager system 50 will now be described with reference to FIG. 38. The system 50 includes functionality and strategic guidance and framework 52, seamless execution 54, and hooks to the existing enterprise systems to maximize returns 56. The strategic guidance is included through tools, such as brand positioning tool 62 and brand strategy tool 64. These tools include not only traditional consulting services but also the brand builder tool and the planner tool. The seamless execution 54 includes best practices, collaboration, project management, campaign management, analytics, and measurement 66. The solution 50 also includes digital asset management 68 which may be provided by any suitable system. For example, U.S. Pat. Nos. 5,903,892 and 5,983,176 describe systems for use in managing digital assets and are incorporated herein by reference. The solution 50 is also integrated into existing enterprise systems, such as customer relationship management (CRM) 70, finance 72, manufacturing 74, and information technology (IT) 76. As depicted in this diagram, the data available through CRM 70, finance 72, manufacturing 74, and IT 76 form the input to the strategic guidance and framework 52 portion of the solution 50.

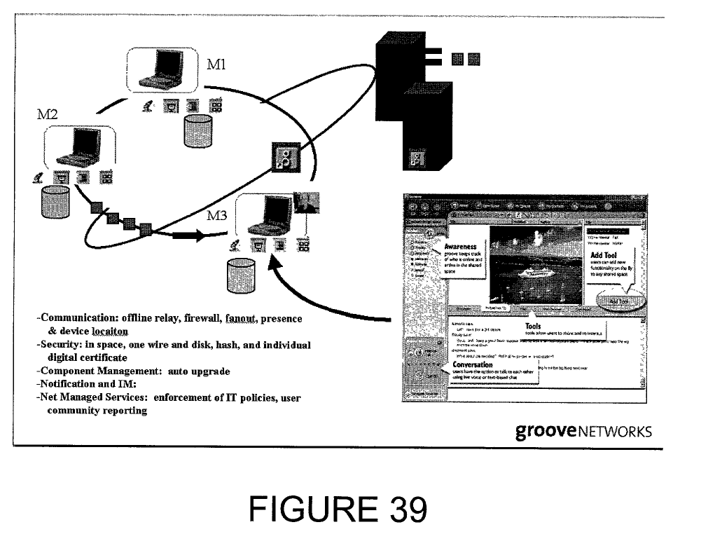

An advantage of the marketing investment manager discussed above in connection with FIGS. 25 to 36 is that it preserves interfaces to existing systems, such as the CRM 72. The solution 50 and solution 80 are preferably implemented in a distributed network through Groove Networks, Inc. of Beverly, Mass. Groove™ of Groove Networks, Inc. provides a distributed framework to allow users to communication and collaborate with each other. Groove™ also allows for the integration of other systems and platforms, such as the tools as shown in FIGS. 25 to 36. It should be understood that other platforms, systems, and applications may be used from other entities than those mentioned above. FIG. 39 provides an illustration of a distributed client server network. As explained in this figure, the Groove system provides communication, security, component management, notification, and net managed services. The Groove™ system provides conversation functionality including live voice or text-based chat and awareness functionality including who is on-line and active in a given shared space. Furthermore, the Groove™ system can be configured to add tools and other new functionality.

The marketing investment manager, such as those illustrated in FIGS. 37 and 38, enable businesses to develop marketing strategies. As depicted in FIG. 1, these strategies include planning strategies, such as through the brand positioning tool and brand planning tool. An outcome of the brand positioning tool is a brand positioning statement that differentiates a branded product and service bundle from the competition in the minds of a target. The brand planning, as discussed above, involves inter alia identifying a mix of marketing elements to pursue growth strategies. The brand planning and brand positioning processes are intended to be performed after relatively long intervals of time, such as on a yearly basis.

The tools in the executing phase expand the strategies defined in the planning phase into more specific strategies for executing. For example, the planning phase may identify a need for advertising and the advertising tool may yield a well-defined advertising strategy and detailed tactics to accomplish the advertising strategy. The other executing tools, such as promotions, endorsements, and PR, likewise take general strategies identified in the planning phase and produce strategies for executing and specific tactics for accomplishing the strategies. The executing tools will likely be performed more frequent than the planning tools, such as two or three times per year.

The marketing investment manager provides access not only to the planning, executing, and tracking tools but provides additional functionality intended to be used on a daily basis by a marketing professional. In general, the planning tools assist in developing strategies, the executing tools assist in executing strategies and specific tactics. The outcome of any of the tools may result in one or more projects that need to be accomplished. FIGS. 25 to 36 provide some examples of such projects, namely the 3 Year Marketing Plan, the Thanksgiving FSI, the New Trade Ad, the Launch Meeting, and the September Email Campaign. The marketing investment manager provides the collaboration unit to assist the marketing professional in communicating with others associated with projects and the project management unit facilitates management of various tasks contained within a project. The campaign management unit assists in the execution and tracking of campaigns, such as an email campaign, while the analytics and measurements facilitate data capture, data mining, data analysis, and other analytics and measurements of results. The marketing investment manager furthermore interfaces with other systems, such as to CRM 70, finance 72, manufacturing 74, and IT 76 units. This interfacing includes sending data and commands to the CRM 70, finance 72, manufacturing 74, and IT 76 units but also receiving data and other feedback from these units in the planning phase.

For example, on a yearly basis, a marketing professional uses the marketing investment manager in developing a brand positioning statement and for brand planning. The marketing professional employs executing tools, such as the advertising tool, at multiple times throughout the year to develop specific advertising strategies and tactics. The outcome of the planning tool such as an email campaign. On a daily basis, the marketing professional collaborates with others in formulating the email campaign. Once completely defined, the professional interfaces with the CRM 70 and IT 76 to execute the campaign. Also, on an on-going basis, the professional uses analytics and measurement units to track the results of the campaign. The following year the results of the campaign, as well as other feedback, are used in the yearly's brand positioning and brand planning.

VII. Business Methods

As explained above, the tools may be provided to users in a variety of settings, such as on a stand-alone computer, as part of a LAN, WAN, or through a network such as the Internet. Furthermore, in a network setting, each person may work independently on the tools or, teams of users may work together on tools or projects. In an ASP setting, users may subscribe to the system and/or to specific tools available through the system. In a local setting, the tools may be licensed for a fee to each user or to an entity based on the number of users. Preferably, the tools form part of a strategy in which initial contact with an entity occurs through a consultant associated with operation of the system. The consulting services introduce the user to the tools and may also assist the user with the tools.

VIII. Modifications

The invention has been described with reference to a set of tools that may be applied to any type of business. According to another aspect of the invention, individual tools or sets of tools may be tailored to specific industries, such as one set of tools for food and beverage businesses, another set of tools for pharmaceutical companies, a third for the automotive industry, etc. The tools can therefore be modified to be company-specific, for instance, to adopt the look and feel of interfaces specific to a company as well as to incorporate proprietary information. The tools could also be tailored for the size of the business, whereby Fortune 500 companies may benefit from one set of tools and smaller companies would be better suited to other tools. Thus, a newspaper tool can be modified to sub-segments within the newspaper industry, such as one tool for internet newspapers, one tool for niche products, one tool for single copy sections, etc. Additionally, while some of the tools can be designed for a particular industry or size of company, tools may be specially designed based on other criteria, such as a set of tools for marketing e-commerce companies or a set of focused tools for use with a generic tool, such as the generic tool of Z Advertising and separate tools focused for advertising on the Internet, through television, or through print media.

As mentioned above, the system provides users with skills, content, and tools to assist the users in their marketing efforts. The system also has relationships with third parties that include advertising agencies, research providers, media providers, and tracking data providers. The third parties may offer content, advertise through the system, and may also take a more interactive role with the users and system. For example, the system may act similar to a business-to-business exchange between the users and the third parties, linking the needs of the users with the services/goods of the third parties. Thus, after a user completes a tool and identifies certain needs for goods/services, the system can assist both in linking the users with the third parties and also in facilitating commerce between the two entities. The tools also preferably have hooks into enterprise systems or other third party applications. These third party applications and enterprise systems include CRM, financial systems, IT, and manufacturing systems. The system could derive revenue from the users and/or third parties through referral fees, on a commission basis, subscription basis, or in other ways. For instance, after a user completes one of the tools, the system could bring in one or more of the third parties in order to assist in the execution of the results of that tool. If the tool was Z Advertising, then the system could link the user with a suitable advertising agency to assist in the execution of the advertising strategy. The system may suggest suitable third parties to the users and enable them to contact the third parties, such as either through the system or through a separate path. Alternatively, the system may pass the results and other data captured through use of the tool to the third parties.

The third parties can therefore interact with the users through the system and may participate not only in the follow-up work after use of a tool but possibly also during execution of a tool. For instance, third parties may have databases or software a user can rely upon to complete a step or sub-step in a tool. The users, system, and third parties preferably exchange data with each other through XML.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What we claim:

1. A method of planning for marketing for an entity, comprising:
performing an assessment of the entity, the performing including:
performing a business assessment,
performing a category assessment,
performing a brand assessment, and
performing a competitive assessment;
deriving a set of conclusions from the assessment of the entity;
identifying opportunities from the set of conclusions;
developing growth strategies designed to realize the opportunities, developing growth strategies including prioritizing the opportunities based on assets and capabilities of the entity;
developing growth tactics based on the growth strategies and opportunities, the growth tactics identifying a mix of marketing elements to pursue the growth strategies; and
developing measurements to monitor effectiveness of the mix of marketing elements;
wherein performing the assessment for each assessment further comprises:
conducting a set of key analyses within each assessment;
deriving a set of findings from the set of key analyses;
drawing a preliminary conclusion from the findings for each set of key analyses; and
identifying relationships across preliminary conclusions to develop final conclusions.

2. The method as set forth in claim 1, wherein the method of planning is computer-implemented.

3. The method as set forth in claim 2, wherein the method of planning is provided through an application service provider.

4. The method as set forth in claim 2, wherein the method of planning is provided locally.

5. The method as set forth in claim 2, wherein the method of planning is provided through a network.

6. The method as set forth in claim 2, wherein the method of planning is provided through a peer-to-peer network.

7. The method as set forth in claim 1, wherein the method is implemented through a series of questions presented to the entity.

8. The method as set forth in claim 7, wherein answers provided by the entity eliminate a set of questions potentially presented to the entity.

9. The method as set forth in claim 7, wherein answers provided by the entity form a basis for questions presented to the entity in subsequent questions.

10. A method of planning for marketing for an entity, comprising:
performing an assessment of the entity, the performing including:
performing a business assessment,
performing a category assessment,
performing a brand assessment, and
performing a competitive assessment;
deriving a set of conclusions from the assessment of the entity;
identifying opportunities from the set of conclusions;
developing growth strategies designed to realize the opportunities, developing growth strategies including prioritizing the opportunities based on assets and capabilities of the entity;
developing growth tactics based on the growth strategies and opportunities, the growth tactics identifying a mix of marketing elements to pursue the growth strategies; and
developing measurements to monitor effectiveness of the mix of marketing elements;
wherein developing growth strategies comprises:
identifying barriers before consumers for the entity;
taking an inventory of marketing assets and capabilities;
assessing each asset and capability on its effectiveness in overcoming each barrier; and
developing a strategy statement specifying how assets and capabilities are used to change how consumers will think, feel, and act.

11. A computer-readable medium for use in performing a method of planning for marketing for an entity, the method comprising:
performing an assessment of the entity, the performing including:
performing a business assessment,
performing a category assessment,
performing a brand assessment, and
performing a competitive assessment;
deriving a set of conclusions from the assessment of the entity;
identifying opportunities from the set of conclusions;
developing growth strategies designed to realize the opportunities, developing growth strategies including prioritizing the opportunities based on assets and capabilities of the entity;
developing growth tactics based on the growth strategies and opportunities, the growth tactics identifying a mix of marketing elements to pursue the growth strategies; and
developing measurements to monitor effectiveness of the mix of marketing elements;
wherein performing the assessment for each assessment further comprises:
conducting a set of key analyses within each assessment;
deriving a set of findings from the set of key analyses;
drawing a preliminary conclusion from the findings for each set of key analyses; and
identifying relationships across preliminary conclusions to develop final conclusions.

12. A computer-readable medium for use in performing a method of planning for marketing for an entity, the method comprising:
performing an assessment of the entity, the performing including:
performing a business assessment,
performing a category assessment,
performing a brand assessment, and
performing a competitive assessment;
deriving a set of conclusions from the assessment of the entity;
identifying opportunities from the set of conclusions;
developing growth strategies designed to realize the opportunities, developing growth strategies including prioritizing the opportunities based on assets and capabilities of the entity;
developing growth tactics based on the growth strategies and opportunities, the growth tactics identifying a mix of marketing elements to pursue the growth strategies; and
developing measurements to monitor effectiveness of the mix of marketing elements;
wherein developing growth strategies comprises:
identifying barriers before consumers for the entity;
taking an inventory of marketing assets and capabilities;
assessing each asset and capability on its effectiveness in overcoming each barrier; and
developing a strategy statement specifying how assets and capabilities are used to change how consumers will think, feel, and act.

13. A collection of marketing tools for use in developing marketing plans for an entity, comprising:
a set of planning tools for use in developing a marketing strategy for the entity;
the set of planning tools for identifying marketing elements to address the marketing strategy;
a set of executing tools for use in defining tactics strategy for the marketing elements;
the set of executing tools for translating the tactics strategy into specific marketing tactics; and
a set of tracking tools for use in monitoring results of the specific marketing tactics;
wherein the collection of tools provides assistance to marketing professionals associated with the entity in planning, executing, and tracking marketing plans.

14. The collection of marketing tools as set forth in claim 13, wherein the set of planning tools includes a brand planning tool for use in developing marketing plans for a brand.

15. The collection of marketing tools as set forth in claim 14, wherein the planning tools include a brand builder tool for use in developing a positioning statement for a brand.

16. The collection of marketing tools as set forth in claim 14, wherein the executing tools includes a promotions tool for use in developing a promotions strategy.

17. The collection of marketing tools as set forth in claim 14, wherein the marketing tools are provided by an application service provider.

18. The collection of marketing tools as set forth in claim 14, wherein the marketing tools are provided within a local network.

19. The collection of marketing tools as set forth in claim 14, wherein the marketing tools are provided in a peer-to-peer network.

20. A method of using marketing tools in developing marketing plans for an entity, comprising:
developing a marketing strategy for the entity using a set of planning tools;
identifying marketing elements to address the marketing strategy using the set of planning tools;
defining tactics strategy for the marketing elements using a set of executing tools;
translating the tactics strategy into specific marketing tactics using the set of executing; and
monitoring results of the specific marketing tactics using a set of tracking tools;
wherein the method of using the marketing tools provides assistance to marketing professionals associated with the entity in planning, executing, and tracking marketing plans.

21. The method of using marketing tools as set forth in claim 20, wherein defining the tactics strategy and translating the tactics into specific marketing tactics is performed a plurality of times for each marketing strategy.

22. A platform for providing a marketing tool for use by a marketing professional in providing marketing services to an entity, comprising:
a tools engine for use in providing the marketing tool to the marketing professional;
a database for containing a matrix;
the matrix defining logic behind the marketing tool;
the tools engine providing an interface to the marketing professional based on prior input received from the marketing professional and from the logic contained within the matrix in the database;
wherein the logic behind the marketing tool is modified by altering contents of the matrix within the database.

23. The platform as set forth in claim 22, wherein the matrix defines a series of questions presented to the marketing professional as part of the marketing tool.

24. The platform as set forth in claim 23, wherein for at least some of the questions, the matrix instructs the engine to formulate questions using the prior input received from the marketing professional.

25. The platform as set forth in claim 23, wherein the matrix instructs the engine to omit a set of questions based on the prior input received from the marketing professional.

26. A marketing investment manager, comprising:
at least one marketing planning tool for use in guiding a user in developing a marketing strategy;
a marketing management solution for use in executing a project associated with the marketing strategy, the marketing management solution including:
a collaboration unit for enabling the user to communicate with others assigned to the project;
a project management unit for enabling the user to manage tasks forming part of the project;
a data analytics and measurement unit for use in tracking results of the project; and
digital asset management for use in managing digital assets used by the marketing management solution in executing the marketing strategy.

27. The marketing investment manager as set forth in claim 26, further comprising customer relationship management for interfacing with the marketing management solution.

28. The marketing investment manager as set forth in claim 26, further comprising a finance system for interfacing with the marketing management solution.

29. The marketing investment manager as set forth in claim 26, further comprising a manufacturing system for interfacing with the marketing management solution.

30. The marketing investment manager as set forth in claim 26, further comprising an information technology system for interfacing with the marketing management solution.

31. The marketing investment manager as set forth in claim 26, wherein the marketing management solution further includes a campaign management unit.
